(19) United States
(12) Patent Application Publication
(10) Pub. No.: US 2026/0280252 A1
(43) Pub. Date: Sep. 17, 2026

(54) Mounting Assembly for a Control Device

(71) Applicant: Lutron Technology Company LLC, Coopersburg, PA (US)

(72) Inventor: Henry Alexander Fiorentini, Darien, IL (US)

(73) Assignee: Lutron Technology Company LLC, Coopersburg, PA (US)

(21) Appl. No.: 19/519,414

(22) PCT Filed: Sep. 13, 2024
(86) PCT No.: PCT/US2024/046535

§ 371 Date: Mar. 31, 2026

Related U.S. Application Data
(60) Provisional application No. 63/582,945, filed on Sep. 15, 2023.
(60) Provisional application No. 63/605,870, filed on Dec. 4, 2023.

(51) Int. Cl. H02G 3/12; F21V 23/00; F21V 23/04; H02G 3/08; H05B 47/11; H05B 47/13; H05B 47/19

(52) U.S. Cl. CPC H02G 3/12; F21V 23/008; F21V 23/045; F21V 23/0464; F21V 23/0471; H02G 3/081; H05B 47/11; H05B 47/13; H05B 47/19

(57) ABSTRACT

A mounting assembly for mounting a control module to a ceiling may comprise a support structure, a cover plate configured to be attached to the control module, and a coupling element for connecting the cover plate to the support structure. The coupling element may be configured to be connected to a drum portion of the support structure and to at least partially extend into an opening of the ceiling. The cover plate may have a front surface and may define a recess through which the control module may extend such that the front portion of the control module is received in the recess. The cover plate may be configured to be attached to the coupling element such that the control module extends through the opening of the ceiling and the front portion of the control module is at least partially located within the opening of the ceiling.

### CROSS-REFERENCE TO RELATED APPLICATIONS

This application claims the benefit of U.S. Provisional Patent Application No. 63/582,945, filed on Sep. 15, 2023, and U.S. Provisional Patent Application No. 63/605,870, filed on Dec. 4, 2023, the entire disclosures of which are hereby incorporated by reference herein in their entirety.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and air-conditioning (HVAC) system may be used to control the temperature in the user environment.

Each load control system may include various control devices, including input devices and load control devices. The load control devices may receive digital messages, which may include load control instructions, for controlling an electrical load from one or more of the input devices. The load control devices may receive the digital messages via radio frequency (RF) signals. Each of the load control devices may be configured to directly control an electrical load. The input devices may be configured to directly control the electrical load via digital messages transmitted to the load control device.

### SUMMARY

As described herein, a mounting assembly for mounting a control module to a ceiling may comprise a support structure, a cover plate configured to be attached to the control module, and a coupling element for connecting the cover plate to the support structure. The coupling element may be configured to be connected to a drum portion of the support structure and to at least partially extend into an opening of the ceiling. The cover plate may have a front surface and may define a recess through which the control module may extend such that the front portion of the control module is received in the recess. The cover plate may be configured to be attached to the coupling element such that the control module extends through the opening of the ceiling and the front portion of the control module is at least partially located within the opening of the ceiling.

In addition, the coupling element may comprise a threaded tube configured to be received in an opening of a drum portion of the support element. For example, the coupling element may comprise a body and a thread extending around the body to form a channel between adjacent wraps of the thread. The mounting structure may comprise a drum portion having a lip extending partially around the drum portion. The lip may be configured to be received in the channel formed between the adjacent wraps of the thread of the coupling element. Further, the coupling element may comprise a mounting plate configured to be connected to the support member via one or more fasteners.

### BRIEF DESCRIPTION OF THE DRAWINGS

FIG. 1 is a diagram of an example load control system.

FIG. 2 is a bottom perspective view of an example control module (e.g., sensor module) that may be installed in a lighting fixture of the load control system of FIG. 1.

FIG. 3 is a top perspective view of the control module shown in FIG. 2.

FIG. 4 is a bottom perspective view of the control module of FIG. 2 shown installed in a ceiling via a mounting system.

FIG. 5 a bottom view of the control module of FIG. 2 shown installed in the ceiling via the mounting system.

FIG. 6 is a side cross-section view of an installation including an example sensor (e.g., the sensor of FIG. 1) mounted to a ceiling via an example mounting assembly taken through the center of the control module.

FIG. 7 is a bottom exploded view of the installation of FIG. 6.

FIG. 8 is a top exploded view of the installation of FIG. 6.

FIG. 9 is an enlarged bottom exploded view of the mounting assembly and the control module of FIG. 6.

FIG. 10 is an enlarged top exploded view of the mounting assembly and the control module of FIG. 6.

FIG. 11 is a side cross-section view of an installation including another example sensor (e.g., the sensor of FIG. 1) mounted to a ceiling via an example mounting assembly taken through the center of the control module.

FIG. 12 is a bottom exploded view of the installation of FIG. 11.

FIG. 13 is a top exploded view of the installation of FIG. 11.

FIG. 14 is an enlarged bottom exploded view of the mounting assembly and the control module of FIG. 11.

FIG. 15 is an enlarged top exploded view of the mounting assembly and the control module of FIG. 11.

FIG. 16 is a perspective view of a support structure (e.g., a mud ring) of the mounting assembly of FIG. 11.

FIGS. 17A and 17B are block diagrams of an example load control system in first and second configurations, respectively.

FIGS. 18A, 18B, and 18C are perspective, plan, and cross-sectional views of another illustrative support structure (e.g., mud ring), in accordance with one or more embodiments described herein.

FIGS. 19A and 19B depict an illustrative coupling element that includes a ramp locking feature, in accordance with one or more embodiments described herein.

FIGS. 20A, 20B, and 20C depict another illustrative coupling element that includes a projection locking feature, in accordance with one or more embodiments described herein.

FIGS. 21A and 21B depict yet another illustrative coupling element that includes a gap-type locking feature, in accordance with one or more embodiments described herein.

### DETAILED DESCRIPTION

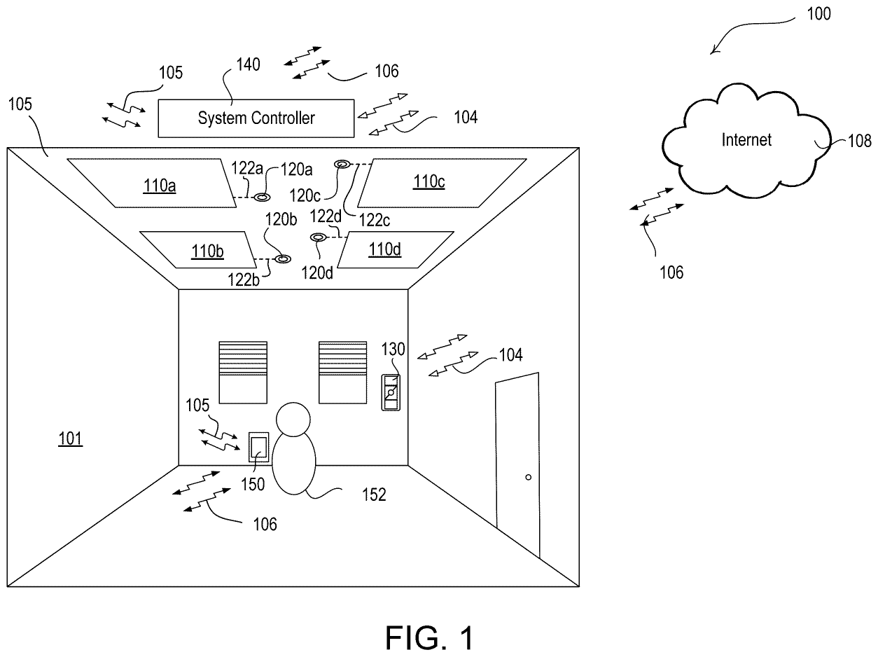

FIG. 1 is a diagram of an example load control system 100 for controlling the amount of power delivered from an alternating-current (AC) power source (not shown) to one or more electrical loads. The load control system 100 may be installed in a load control environment, such as a room 101 of a building. The load control system 100 may comprise a plurality of control devices configured to communicate with each other via wireless signals, e.g., radio-frequency (RF) signals 104, 105. For example, the load control system 100 may include control-source devices, control-target devices, and/or a system controller 110 that may be configured to transmit and receive the RF signals 104, 105. The RF signals 104, 105 may use a proprietary RF protocol, such as the CLEAR CONNECT protocol (e.g., the CLEAR CONNECT TYPE A protocol and/or the CLEAR CONNECT TYPE X protocol as developed by Lutron Electronics Co., Inc.). Alternatively, the RF signals 104, 105 may be transmitted using a different RF protocol, such as, a standard protocol, for example, one of WI-FI, BLUETOOTH, BLUETOOTH LOW ENERGY (BLE), ZIGBEE, Z-WAVE, THREAD, KNX-RF, ENOCEAN RADIO protocols, or a different standard or proprietary protocol. Alternatively or additionally, the load control system 100 may comprise a wired digital communication link coupled to one or more of the control devices to provide for communication between the control devices.

The control devices of the load control system 100 may comprise a number of control-source devices (e.g., input devices operable to transmit messages in response to receiving user inputs, detecting occupancy/vacancy conditions, measuring ambient light intensity level, etc.) and a number of control-target devices (e.g., load control devices operable to receive messages and control electrical loads in response to the received messages). A single control device of the load control system 100 may operate as both a control-source and a control-target device. For example, the control-source device may be an originating device or intermediary device from which a message is originated and a control-target device may be a destination device or intermediary device to which the message is transmitted.

The lighting control system 100 may comprise one or more lighting fixtures 110a, 110b, 110c, 110d that may be installed in the room 101, e.g., in a ceiling 102 of the room 101. Each lighting fixture 110a-110d may include a lighting load (e.g., an LED light source) and a respective lighting control device (e.g., an LED driver, ballast, dimming or switching module, or any combination of such devices) for controlling the respective lighting load of the lighting fixture 110a-110d. The lighting control devices may be control-target devices configured to control a respective lighting load in response to control instructions received in digital messages.

The control-source devices of the load control system 100 may be used to control the lighting fixtures 110a-110d. The control-source devices may be input devices configured to communicate messages (e.g., digital messages) to the control-target devices of the load control system 100, such as the lighting control devices in the lighting fixtures 110a-110d, e.g., via the RF signals 104, 105. The control-source devices may transmit the messages for controlling (e.g., indirectly controlling) the amount of power provided to the lighting loads by the respective lighting control devices in the respective lighting fixtures 110a-110d. The messages may include control instructions (e.g., load control instructions) or another indication that causes the lighting control devices to determine load control instructions for controlling the respective lighting loads. The control-sources devices of the load control system 100 may comprise, for example, a control device, such a remote control device 130, which may be configured to transmit messages to the lighting control devices in the respective lighting fixture 110a-110d via the RF signals 104 in response to actuations of one or more buttons of the remote control device 130.

The load control system 100 may include control modules (e.g., sensor devices and/or fixture controllers), such as control modules 120a, 120b, 120c, 120d. The control modules 120a-120d may each be mounted to the ceiling 102 of the room 101 adjacent to respective ones of the lighting fixtures 110a-110d. The control modules 120a-120d may each be electrically connected to a respective lighting control device within the lighting fixtures 110a-110d via a respective communication link 122a-122d (e.g., a wired communication link) for controlling lighting loads. The control modules 120a-120d may include one or more sensors (e.g., sensing circuits) for controlling the lighting loads within the respective lighting fixtures 110a-110d. For example, the control modules 120a-120d may include an occupancy sensing circuit (e.g., may operate as an occupancy sensor and/or a vacancy sensor) and/or a daylight sensing circuit (e.g., may operates as a daylight sensor). The control modules 120a-120d may be control-source devices that transmit digital messages to respective lighting control devices to which they are connected via the respective wired communication links 122a-122d. The control modules 120a-120d may also, or alternatively, be control-target devices for receiving digital messages from other devices in the system, such as the remote control device 130 or another control-source device, (e.g., on a wireless communication link via the RF signals 104, 105) for controlling the respective lighting control devices to which the control modules 120a-120d are connected.

The occupancy sensing circuit in the control modules 120a-120d may be configured to detect occupancy and/or vacancy conditions in the room 101 in which the load control system 100 is installed. The control modules 120a-120d may control the lighting control devices in the respective lighting fixtures 110a-110d in response to the occupancy sensors detecting the occupancy or vacancy conditions. The control modules 120a-120d may each also operate as a vacancy sensor, such that messages are transmitted in response to detecting a vacancy condition (e.g., messages may or may not be transmitted in response to detecting an occupancy condition). The daylight sensing circuit in the control modules 120a-120d may be configured to measure an ambient light intensity level in the visible area of the room 101 in which the load control system 100 is installed. The control modules 120a-120d may control the lighting control devices in the respective lighting fixture 110a-110d in response to the ambient light intensity level measured by the respective daylight sensing circuit.

The control modules 120a-120d may each comprise a memory or other computer-readable storage medium configured to store instructions thereon for being executed by a control circuit thereon. Each control module 120a-120d may store in the memory unique identifiers of other devices in the load control system 100 with which the control module is associated to enable recognition of messages from and/or transmission of messages to associated control devices. For example, each control module 120a-120d may store in the memory the unique identifier of the remote control device 130 with which the control module is associated and thus configured to be responsive to messages from remote control device 130. Other control variations are possible.

The control modules 120a-120d may each comprise one or more wireless communication circuits for transmitting and/or receiving messages, e.g., via the RF signals 104, 105. A first wireless communication circuit of each of the control modules 120a-120d may be configured to communicate on a first wireless communication link (e.g., a wireless network communication link) and/or communicating using a first wireless protocol (e.g., a wireless network communication protocol, such as the CLEAR CONNECT and/or THREAD protocols) via the RF signals 104. A second wireless communication circuit of each of the control modules 120a-120d may be configured to communicate on a second wireless communication link (e.g., a short-range wireless communication link) and/or communicating using a second wireless protocol (e.g., a short-range wireless communication protocol, such as the BLUETOOTH and/or BLUETOOTH LOW ENERGY (BLE) protocols) via the RF signals 105. The first and second communication circuits may be separate modules or housed in a common module.

The control modules 120a-120d may each comprise one or more wired communication circuits for transmitting and/or receiving signals and/or messages via the respective communication links 120a-120d (e.g., wired power/communication links). For example, each control module 120a-120d may use the wired communication circuit to communicate messages with the respective lighting fixture 110a-110d via the respective communication link 122a-122d. Each of the communication links 122a-122d may be used for providing communications and/or power to/from each of the lighting fixtures 110a-110d. For example, each of the communication links 122a-122d may comprise, for example, a Digital Addressable Lighting Interface (DALI) link or another digital communication link. Each of the communication links 122a-122d may be used by the respective control module 120a-120d to transmit messages (e.g., including commands) to the respective lighting control devices of the respective lighting fixture 120a-120d for turning the respective lighting load on and/or off and controlling an intensity level and/or color (e.g., color temperature) of the respective lighting loads. Each control module 120a-120d may receive messages (e.g., including feedback information) from the respective lighting control device that indicate the on/off state, the intensity level, and/or the color of the respective lighting loads. In addition, the lighting control devices in each of the lighting fixtures 110a-110d may each receive power from an AC power source (not shown) and may each supply power to the respective control module 120a-120d via the respective communication link 122 a-122d. Though each of the communication links 122a-122d may be described herein as a single link, each of the communication links 122a-122d may be comprised of multiple links. For example, the lighting control devices of each lighting fixture 110a-110d may provide power to the respective control module 120a-120d via a two-wire power bus, while communications may be performed between the control module and the lighting control devices using an analog communication link, such as a 0-10V control link or another communication link through which power may not be provided (e.g., an RS-485 digital communication link). While the control modules 120a-120d of FIG. 1 are described as including one or more sensors (e.g., sensing circuits) and one or more wireless communication circuits, the control module 120a-120d may also just comprise the one or more wireless communication circuits (e.g., one or more of the control modules 120a-120d may not include the sensors).

The load control system 100 may include a system controller 140 that is configured to transmit and/or receive messages via wired and/or wireless communications. For example, the system controller 140 may be configured to transmit and/or receive the RF signals 104, to communicate with one or more control devices (e.g., control-source devices and/or control-target devices, such as the control modules 120a-120d). The system controller 140 may communicate digital messages between associated control devices that are configured to control or be controlled by the other. The system controller 140 may be coupled to one or more wired control devices (e.g., control-source devices and/or control-target devices) via a wired digital communication link. The system controller 140 may also, or alternatively, be configured to communicate on a second wireless communication link (e.g., a standard communication link) and/or communicating using a second wireless protocol (e.g., a standard communication protocol, such as the Internet protocol (IP) and/or WI-FI protocol), via RF signals 106. For example, the system controller 140 may be configured to transmit and/or received messages on a network 108, such as the Internet, via the RF signals 106.

The system controller 140 may be configured to transmit and receive messages between control devices. For example, the system controller 140 may transmit messages to the control modules 120a-120d for controlling the lighting loads in the lighting fixtures 110a-110d in response to the messages received from the remote control device 130 (e.g., via the RF signals 104). The messages may include configuration data for configuring the control devices (e.g., the control modules 120a-120d) and/or control data (e.g., commands) for controlling the lighting loads in the lighting fixtures 110a-110d.

The load control system 100 may be commissioned to enable control of the lighting loads in the lighting fixtures 110a-110d based on commands communicated from the control devices (e.g., the remote control device 130) to the control modules 120a-120d for controlling the lighting loads in the lighting fixtures 110a-110d. For example, the remote control device 130 may be associated with the control modules 120a-120d of the lighting fixtures 110a-110d. Association information may be stored on the associated devices, which may be used to communicate and identify messages and/or commands at associated devices for controlling electrical devices in the load control system 100. The association information may include the unique identifier of one or more of the associated devices. The association information may be stored at the control modules 120a-120d, the system controller 140, or at other control devices that may be implemented to enable communication and/or identification of messages between the control devices.

A network device 150 may be in communication with the control modules 110a-110d and/or the system controller 140 for commissioning and/or controlling the control devices of the load control system 100. The network device 150 may comprise a wireless phone, a tablet, a laptop, a personal digital assistant (PDA), a wearable device (e.g., a watch, glasses, etc.), or other computing device. The network device 150 may be operated by a user 152. The network device 150 may be configured to communicate with the system controller 140 and/or control devices connected by transmitting and/or receiving messages using a standard wireless protocol (e.g., via the RF signals 106) via the network 108. In addition, the network device 150 may be configured to communicate with the control modules 110a-110d directly by transmitting and/or receiving messages via the short-range wireless communication link (e.g., using the RF signals 105). Further, the network device 150 may be configured to transmit and/or receive beacon signals that may be used to commission the load control system 100 via the short-range wireless communication link (e.g., using the RF signals 105).

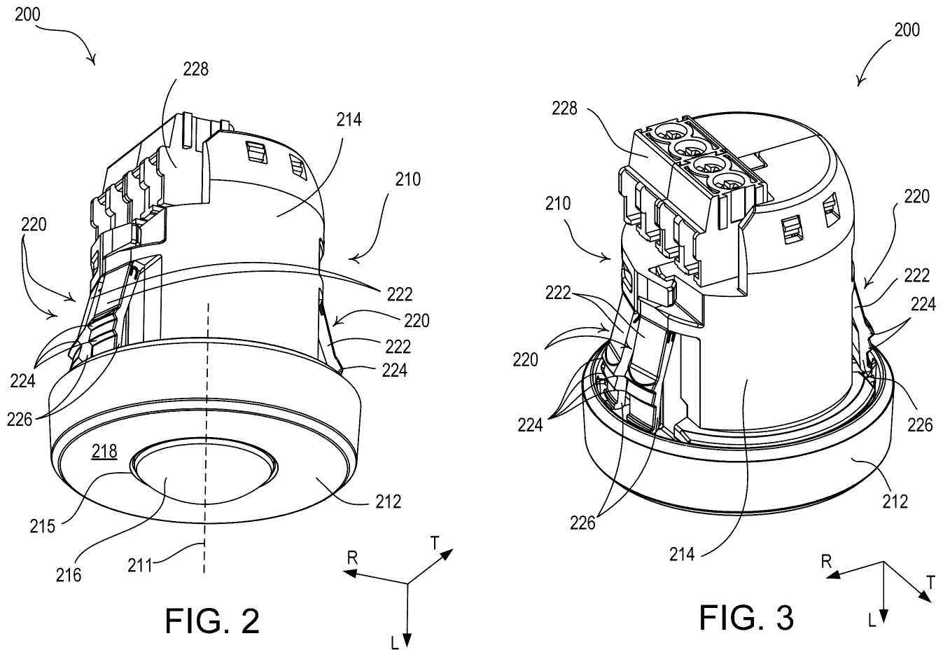

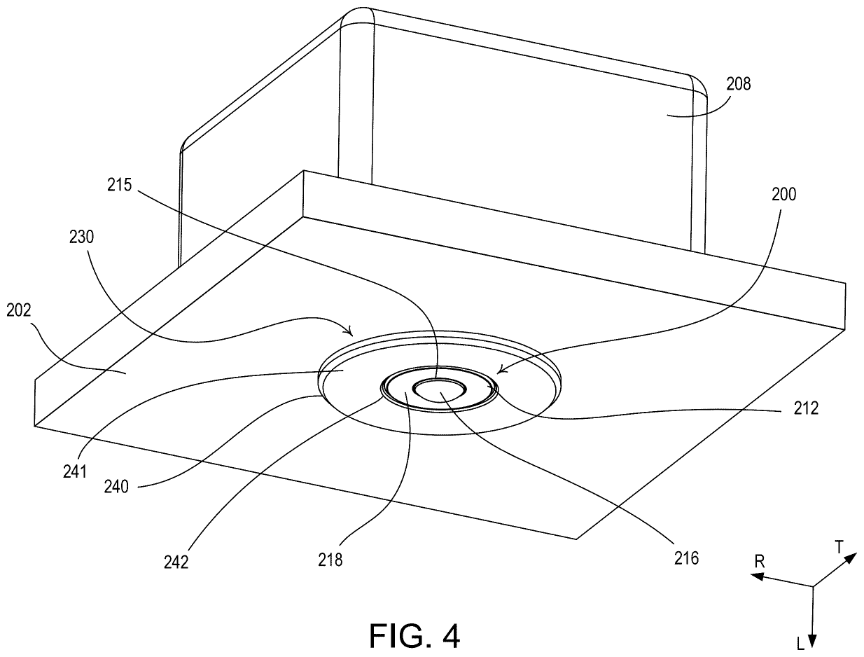

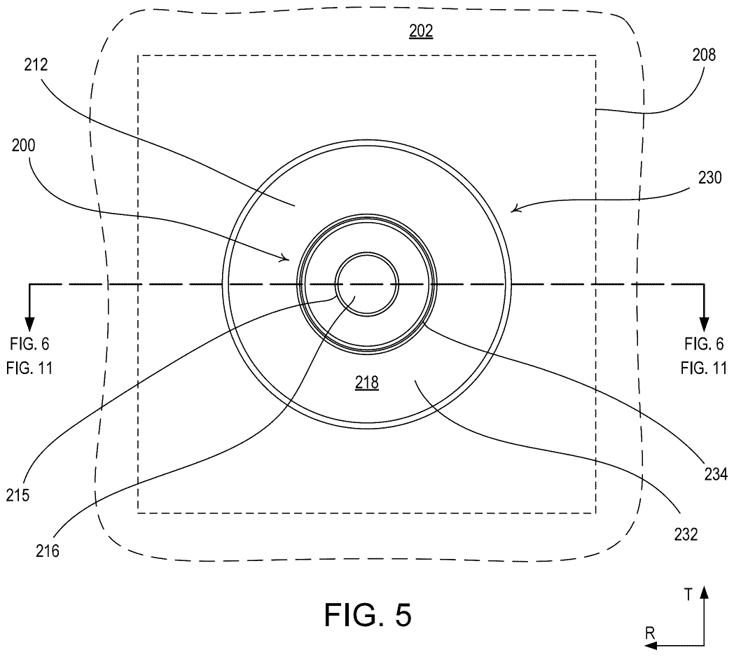

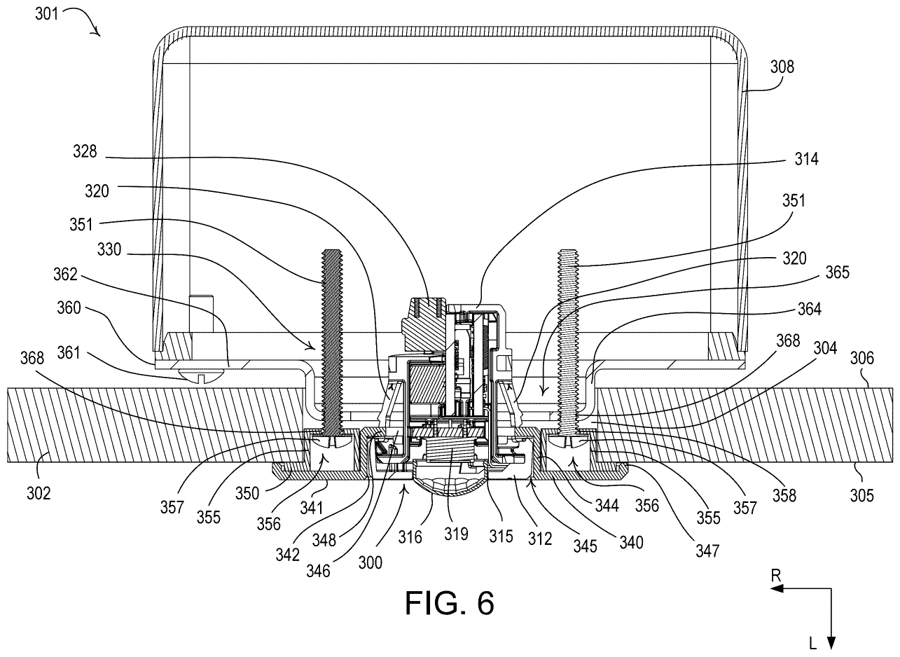

FIG. 2 is a bottom perspective view and FIG. 3 is a top perspective view of an example control module 200 (e.g., a sensor module), which may be deployed as the control modules 120a-120d for the load control system 100 shown in FIG. 1. FIG. 4 is a bottom perspective view and FIG. 5 is a bottom view of the control module 200 shown installed in a ceiling 202 (e.g., to the ceiling 102 of the room 101) via a mounting system 230. The control module 200 may be configured to be mounted to the ceiling 202 near a lighting fixture (e.g., one of the lighting fixtures 110a-110d) and electrically connected to different types of lighting control devices, such as different types of LED drivers, for example, for controlling one or more lighting loads in the lighting fixtures. The control module 200 may be electrically connected to the lighting control device(s) (e.g., via a wired communication link and/or control link) to enable control of the lighting control device(s) in response to information provided from the control module 200.

The control module 200 may comprise an enclosure 210 that may extend in a longitudinal direction L and may be centered about a central axis 211 of the control module 200 (e.g., that also extends in the longitudinal direction L). The enclosure 210 may have a front portion 212 (e.g., a cover plate or a bezel) and a rear portion 214 (e.g., a housing). The mounting assembly 230 may comprise a cover plate 240 to which the control module 200 (e.g., the rear portion 214 of the enclosure 210) may be connected. For example, the control module 200 may be received in an opening 242 in a front surface 241 of the cover plate 240. The mounting assembly 230 may be mounted to and supported by a structure, such as a junction box 208 (e.g., which may be located on an opposite side of the ceiling 202 as the cover plate 240). In some examples, the mounting assembly 230 may be mounted to and supported by the ceiling 202 itself. When the control module 200 is installed in the ceiling 202, the rear portion 214 of the enclosure 210 may be received through an opening (not shown) in the ceiling 202. In addition, at least a portion of the cover plate 240 may be received through the opening in the ceiling 202. The cover plate 240 may be configured to cover the opening of the ceiling 202. For example, the front portion 212 of the enclosure 210 of the control module 200 and the cover plate 240 of the mounting assembly 230 may be visible to a user when the control module 200 is installed in the ceiling 202, and the rear portion 214 of the enclosure 210 of the control module 200 may be hidden from view from the user when the control module 200 is installed in the ceiling 202.

The control module 200 may comprise a lens 216 received in an aperture 215 in a front surface 218 of the front portion 212 of the enclosure 210. The aperture 215 and the lens 216 may be centered about the central axis 211 of the control module 200. The lens 216 may be dome-shaped and made of at least a partially infrared or visible light transparent material to allow infrared energy to enter the enclosure 210 through the aperture 215. The control module 200 may comprise an occupancy detection circuit having a detector (not shown). For example, the occupancy detection circuit may comprise a passive infrared (PIR) sensing circuit, and the detector may comprise a pyroelectric detector. The detector may be configured to detect infrared energy from an occupant in a load control environment (e.g., such as the room 101 shown in FIG. 1) that may enter the control module 200 through the aperture 215 of the front portion 212 of the enclosure 210 (e.g., through the lens 216). The control module 200 may be configured to detect motion in the load control environment (e.g., occupancy and/or vacancy conditions) in response to the infrared energy detected by the detector. In addition, the control module 200 may comprise a photosensing circuit (e.g., a daylight sensor circuit) and/or another sensing circuit. In some examples, the control module 200 may not comprise any sensing circuits (e.g., the control module 200 may not include the lens 216 when the control module 200 does not include any sensing circuits).

The rear portion 214 of the enclosure 210 of the control module 200 may comprise one or more clips 220 for connecting the control module 200 to the mounting assembly 230 (e.g., to the cover plate 240 of the mounting assembly 230). The clips 220 may each comprise a respective arm 222 and a plurality of teeth 224 located at an end 226 of the respective arm 222. The clips 220 may be configured to attach (e.g., snap) to the cover plate 240 of the mounting assembly 230 (e.g., as will be described in greater detail below). One or more of the teeth 224 of the arms 222 may be configured to engage the cover plate 240 for mounting (e.g., locking) the control module 200 within the opening 242 in the front surface 241 of the cover plate 240 of the mounting assembly 230 (e.g., within the opening in the ceiling 202).

The control module 200 may comprise a connector 228 that may allow for connection to an external power source (e.g., such as an external direct-current (DC) power source) and/or an external load control device for controlling the one or more lighting loads located in the lighting fixture (e.g., such as an LED driver for controlling an LED light source). For example, the connector 228 may comprise two electrical terminals configured to receive wires that may be connected to the power source to allow the control module 200 to receive power for powering the electrical circuitry of the control module 200. In addition, the connector 228 may comprise two electrical terminals that may receive wires that may be connected to the load control device via a wired communication link and/or a wired control link for controlling the one or more lighting loads (e.g., such as the communication links 122a-122d shown in FIG. 1).

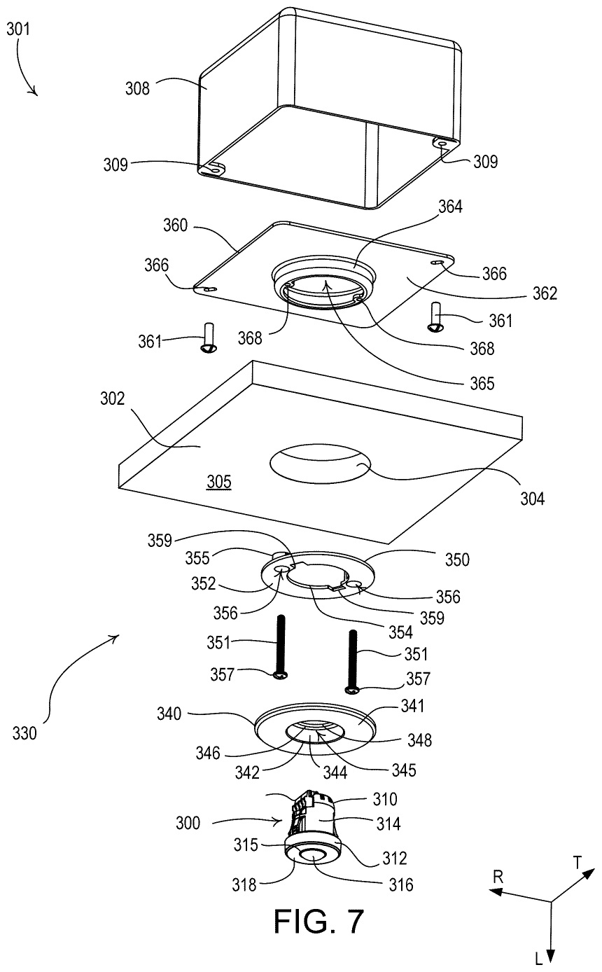

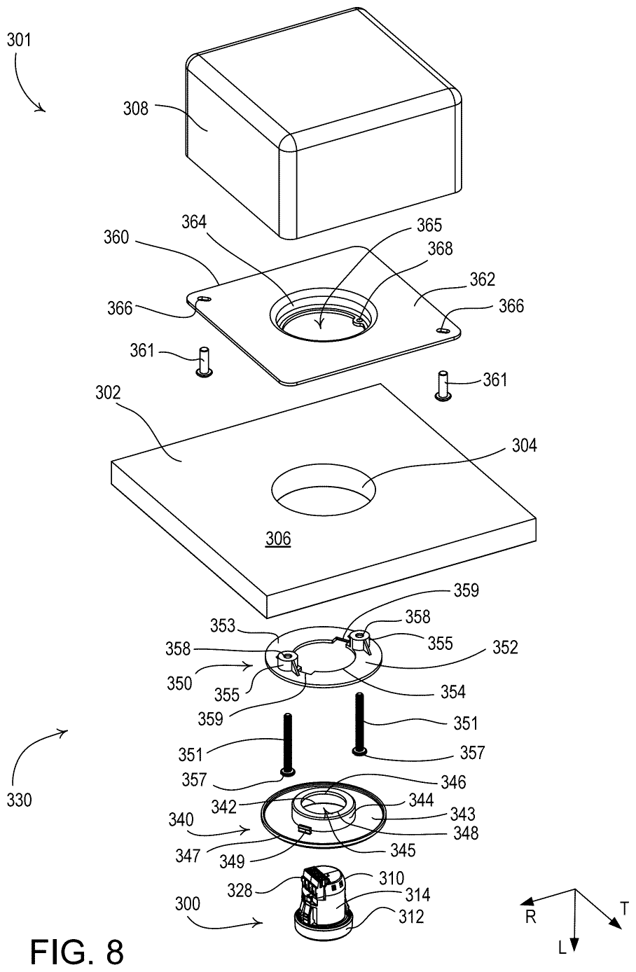

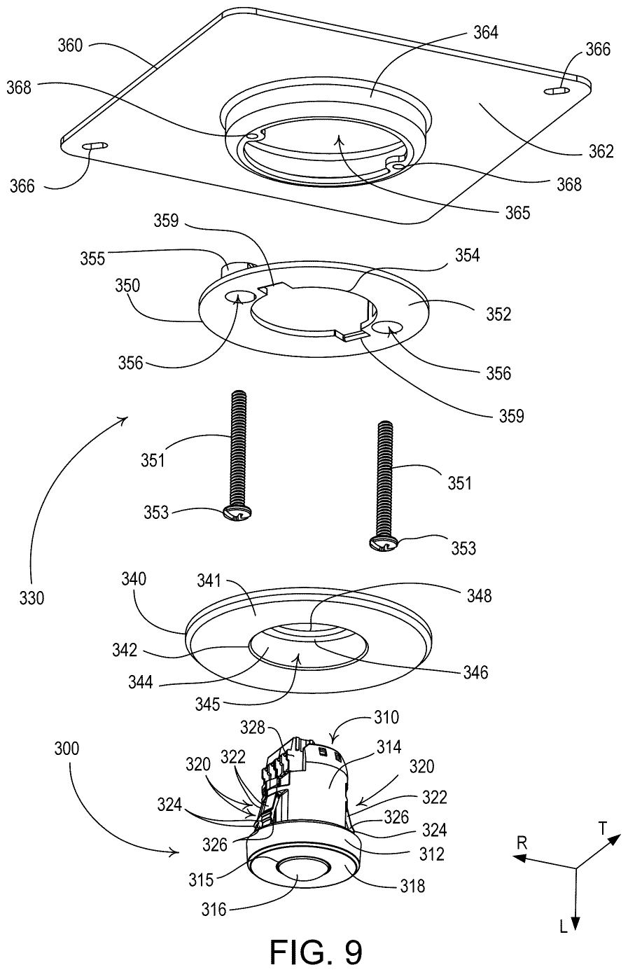

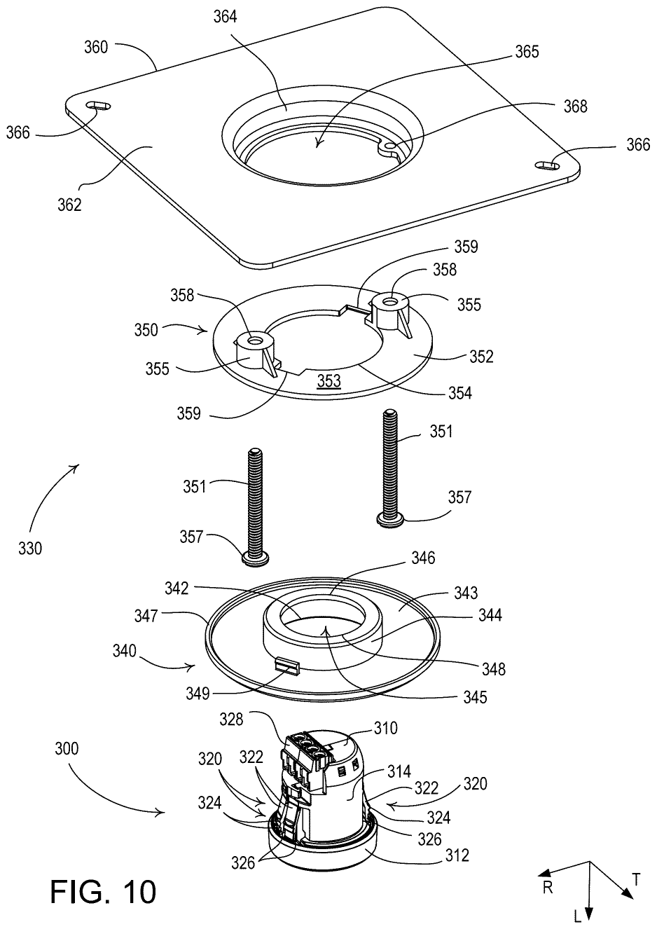

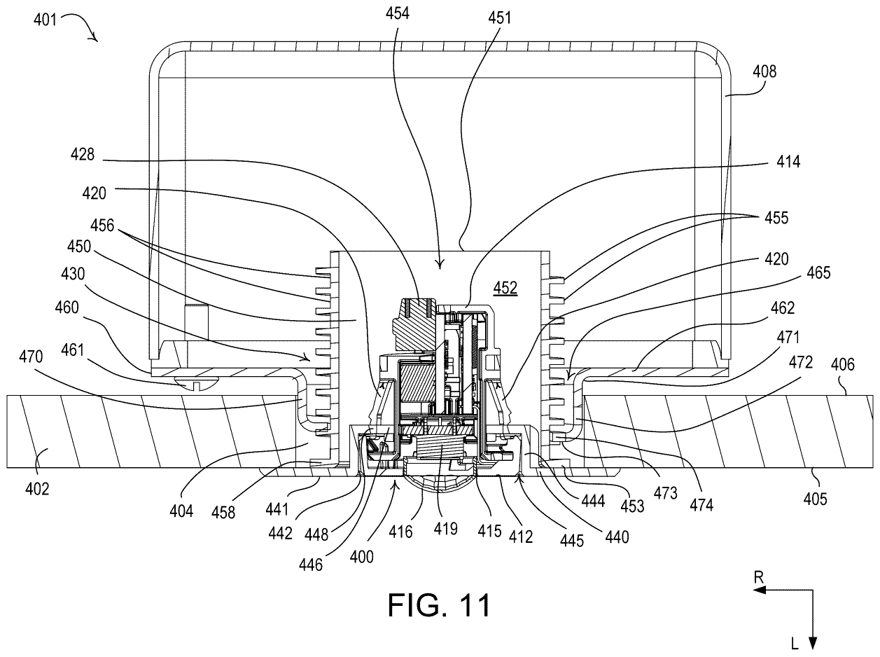

FIG. 6-10 illustrate an example mounting assembly 330 (e.g., such as the mounting assembly 230) for mounting a control module 300 (e.g., such as the control modules 120a-120d for the load control system 100 shown in FIG. 1 and/or the control module 300 shown in FIGS. 2-5). FIG. 6 is a side cross-section view of an installation 301 including the control module 300 mounted to a ceiling 302 via the mounting assembly 330 taken through the center of the control module 300 (e.g., through the line shown in FIG. 5). FIG. 7 is a bottom exploded view and FIG. 8 is a top exploded view of the installation 301 shown in FIG. 6. FIG. 9 is an enlarged bottom exploded view and FIG. 10 is an enlarged bottom exploded view of the control module 300 and the mounting assembly 330. For example, the control module 300 may be identical to the control module 200 shown in FIGS. 2-5. The control module 300 may be configured to be mounted to the ceiling 302 near a lighting fixture (e.g., one of the lighting fixtures 110a-110d) and electrically connected to different types of lighting control devices, such as different types of LED drivers, for example. The control module 300 may be electrically connected to the lighting control device(s) (e.g., via a wired communication link and/or control link) to enable control of the lighting control device(s) in response to information provided from the control module 300. When the control module 300 is mounted to the ceiling 302, the mounting assembly 330 may be connected to (e.g., supported by) a structure, such as a junction box 308 that may be located above the ceiling 302. As shown in FIGS. 7 and 8, the ceiling 302 may comprise an opening 304 through which the mounting assembly 330 may extend for mounting the control module 300 to the ceiling 302 (e.g., to the junction box 308). In some examples, the mounting assembly 330 may be supported by the ceiling 302 itself (e.g., mounted to a rear surface 306 of the ceiling 302).

The control module 300 may comprise an enclosure 310 (e.g., the enclosure 210) that may include a front portion 312 (e.g., the front portion 212) and a rear portion 314 (e.g., the rear portion 214). The control module 300 may comprise a lens 316 received in an aperture 315 in a front surface 318 of the front portion 312 of the enclosure 310 (e.g., such as the lens 216 received in the aperture 215 in the front surface 218 of the front portion 212 of the enclosure 200). The lens 316 may be dome-shaped and made of at least a partially infrared or visible light transparent material to allow infrared energy to enter the enclosure 310 through the aperture 315. The control module 300 may comprise an occupancy detection circuit having a detector 319 (FIG. 6). For example, the occupancy detection circuit may comprise a passive infrared (PIR) sensing circuit, and the detector 319 may comprise a pyroelectric detector. The detector 319 may be configured to detect infrared energy from an occupant in a load control environment (e.g., such as the room 101 shown in FIG. 1) that may enter the control module 300 through the aperture 315 of the front portion 312 of the enclosure 310 (e.g., through the lens 316). The control module 300 may be configured to detect motion in the load control environment (e.g., occupancy and/or vacancy conditions) in response to the infrared energy detected by the detector 319. In addition, the control module 300 may comprise a photosensing circuit (e.g., a daylight sensor circuit) and/or another sensing circuit. In some examples, the control module 300 may not comprise any sensing circuits (e.g., the control module 300 may not include the lens 316 when the control module 300 does not include any sensing circuits).

The control module 300 may comprise a connector 328 that may allow for connection to an external power source (e.g., such as an external direct-current (DC) power source) and/or an external load control device for controlling a lighting load located in the lighting fixture (e.g., such as an LED driver for controlling an LED light source). For example, the connector 328 may comprise two electrical terminals configured to receive wires that may be connected to the power source to allow the control module 300 to receive power for powering the electrical circuitry of the control module 300. In addition, the connector 328 may comprise two electrical terminals that may receive wires that may be connected to the load control device via a wired communication link and/or a wired control link for controlling the lighting load (e.g., such as the communication links 122a-122d shown in FIG. 1).

The mounting assembly 330 may comprise a cover plate 340 (e.g., a wall plate or face plate), a coupling element 350 (e.g., a mounting plate), and a support member 360 (e.g., a mud ring). The support member 360 may comprise a plate portion 362 and a drum portion 364, which may define an opening 365 that extends through the support member 360. As shown in FIGS. 7 and 8, the support member 360 may be configured to be attached to the junction box 308. For example, the support member 360 may be secured to the junction box 308 via respective fasteners 361 (e.g., screws) received through openings 366 (e.g., slots) in the plate portion 362 of the support member 360 and screw holes 309 of the junction box 308. As shown in FIG. 6, the drum portion 364 may be configured to extend into the opening 304 of the ceiling 302.

The coupling element 350 may be configured to mechanically couple the cover plate 340 to the support member 360 of the mounting assembly 330 (e.g., and thus to the junction box 308). The coupling element 350 may comprise a plate portion 352 that defines a central opening 354. The coupling element 350 may also comprise drum portions 355 (e.g., counterbores) that extend from a rear surface 353 of the plate portion 352 and define respective recesses 356. The coupling element 350 may be mechanically coupled to the support member 360 via respective fasteners 351 (e.g., screws) received through openings 358 in the respective drum portions 355 of the coupling element 350 and respective openings 368 on the drum portion 364 of the support member 360. Heads 357 of the respective fasteners 351 may be sized so as to not fit through the respective openings 358 on the drum portions 355 of the coupling member 350. In some examples, the coupling element 350 may not comprise the drum portions 355, but may simply comprise openings (e.g., such as the openings 358) in the plate portion 352). When the fasteners 351 are received through the openings 358 in the respective drum portions 355 of the coupling element 350 and the respective openings 368 on the drum portion 364 of the support member 360, the heads 357 of the respective fasteners 351 may be located within the recesses 356 of the drum portions 355 of the coupling element 350. As the fasteners 351 are tightened, the coupling element 350 may move towards the support member 360 and the drum portions 364 of the support member 360 may be received with in the opening 304 in the ceiling 302 (e.g., as shown in FIG. 6). The position of the coupling element 350 with respect to the support member 360 (e.g., along the longitudinal axis L) may be adjustable to account for different thicknesses of the ceiling 302. For example, the fasteners 351 may be tightened until the rear surface 353 of the coupling element 350 abuts a front surface 305 of the ceiling 302.

The control module 300 (e.g., the rear portion 314 of the enclosure 310) may be connected to the cover plate 340 of the mounting system 330. The cover plate 340 may comprise a front surface 341 defining a front opening 342 through which the control module 300 may be received. The cover plate 340 may also comprise a sidewall 344 (e.g., a cylindrical sidewall) that extends from a rear surface 343 of the cover plate 340. The sidewall 344 may define a recess 345 that is surrounded by the front opening 342 at the front surface 341 of the cover plate 340. The sidewall 344 may extend from the rear surface 343 of the cover plate 340 to a lip 346 (e.g., flange portion) that defines (e.g., surrounds) a rear opening 348 of the recess 345. The cover plate 340 may further comprise a rim 347 that extends from the rear surface 343 of the cover plate 340 and surrounds the rear surface 343 (e.g., the periphery or circumference of the rear surface 343).

As shown in FIGS. 9 and 10, the rear portion 314 of the enclosure 310 of the control module 300 may comprise one or more clips 320 (e.g., such as the clips 220 shown in FIGS. 2-5) for connecting the control module 300 to the mounting assembly 330 (e.g., to the cover plate 332 of the mounting assembly 330). The clips 320 may each comprise a respective arm 322 and a plurality of teeth 324 located at an end 326 of the respective arm 322. The clips 320 may be configured to attach (e.g., snap) to the cover plate 340 of the mounting assembly 330. One or more of the teeth 324 of the clips 320 may be configured to engage the lip 346 of the cover plate 340 for mounting (e.g., locking) the control module 300 within the recess 345 of the cover plate 340 of the mounting assembly 340 (e.g., within the opening 304 in the ceiling 302). The clips 320 may be resiliently biasable, for example, towards the rear portion 314 of the enclosure 310 of the control module 300. As the control module 300 is inserted through the front opening 342 in the front surface 341 of the cover plate 340 and into the recess 345 of the cover plate 340, the arms 322 of the respective clips 320 may be configured to bend in towards the rear portion 314 of the enclosure 310 such that the teeth 324 are biased toward the rear portion 314 of the enclosure 310. The lip 346 of the cover plate 340 may press the clips 320 toward the rear portion 314 of the enclosure 310 such that the clips 320 fit within the rear opening 348 of the cover plate 340 as the control module 300 is inserted through the front opening 342 in the front surface 341 of the cover plate 340 and into recess 345 of the cover plate 340. The control module 300 may be secured in position within the recess 345 of the cover plate 340 when one or more of the teeth 324 of the clips 320 contact the lip 346 of the cover plate 340. As shown in FIG. 6, the front portion 312 of the enclosure 310 may be received within the recess 345 of the cover plate 340 such that the front surface 318 of the front portion 312 of the enclosure 310 is substantially flush with the front surface 341 of the cover plate 340. In this fashion, the front portion 312 of the enclosure 310 is recessed into the opening 304 of the ceiling 302 and the front surface 318 of the front portion 312 of the enclosure 310 is substantially flush with the front surface 305 of the ceiling 302.

The cover plate 340 may further comprise snaps 349 extending from the rear surface 343 of the cover plate 340. The snaps 349 of the cover plate 340 may be received in respective notches 359 in the central opening 354 of the plate portion 352 of the coupling element 350 for attaching the cover plate 340 and the control module 300 to the coupling element 350 and thus the support member 360. When the cover plate 340 is connected to the support member 360 via the coupling element 350, the cover plate 340 (e.g., and the coupling element 350) may cover the opening 304 of the ceiling 302. When the rear surface 353 of the coupling element 350 abuts the front surface 305 of the ceiling 302, the rim 347 of the cover plate 340 may also abut (e.g., or be positioned very close to) the front surface 305 of the ceiling 302. As shown in FIG. 6, the control module 300 may extend through the opening 304 in the ceiling 302 and into the junction box 308. At least a portion of the front portion 312 of the enclosure 310 of the control module 300 may be located within the opening 304 of the ceiling 302 (e.g., at least a portion of the front portion 312 may extend beyond the front surface 305 of the ceiling 302). The front portion 312 of the enclosure 310 of the control module 300 and the cover plate 340 of the mounting assembly 330 may be visible to a user when the control module 300 is installed in the ceiling 302 via the mounting assembly 330. In addition, the rear portion 314 of the enclosure 310 of the control module 300 and the opening 304 of the ceiling 302 may be hidden from view from the user when the control module 300 is installed in the ceiling 302 via the mounting assembly 330.

The wires that are connected to the control module 300 (e.g., for power and/or communication) may extend from the lighting fixture in which the load control device is located through the junction box 408 to the connector 328. Before the control device 300 and the cover plate 340 are mounted to the ceiling 302, the wires may be pulled (e.g., routed) from the lighting fixture through the junction box 308, the opening 365 of the support member 360, and the central opening 354 of the coupling member 350. The control module 300 may be connected to (e.g., snapped onto) the cover plate 340. The wires may then be connected to the connector 328 of the control module 300 and the cover plate 340 may be connected to (e.g., snapped onto) the coupling portion 350 to mount the control module 300 to the ceiling 302.

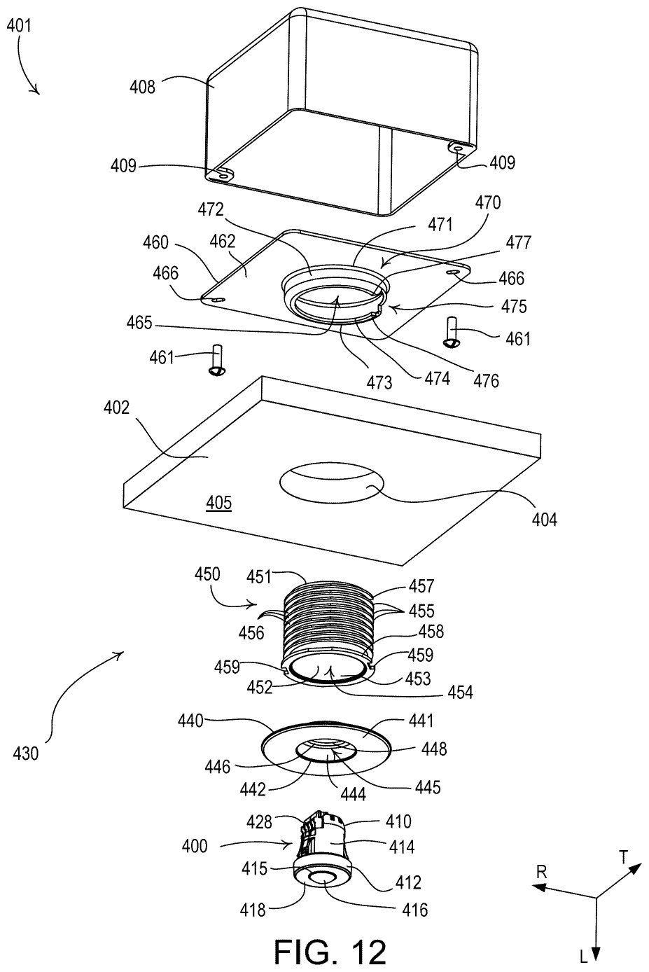

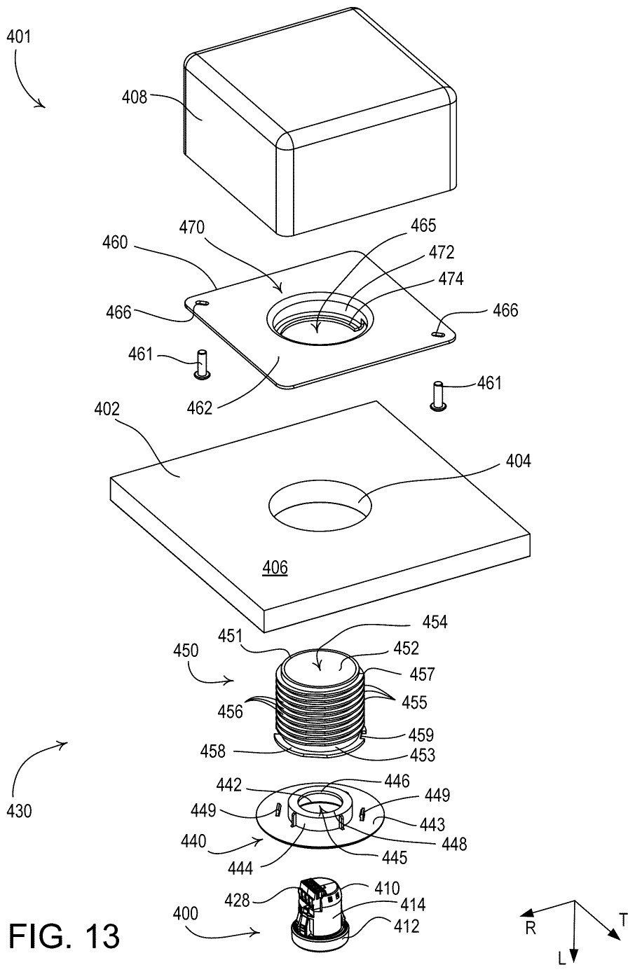

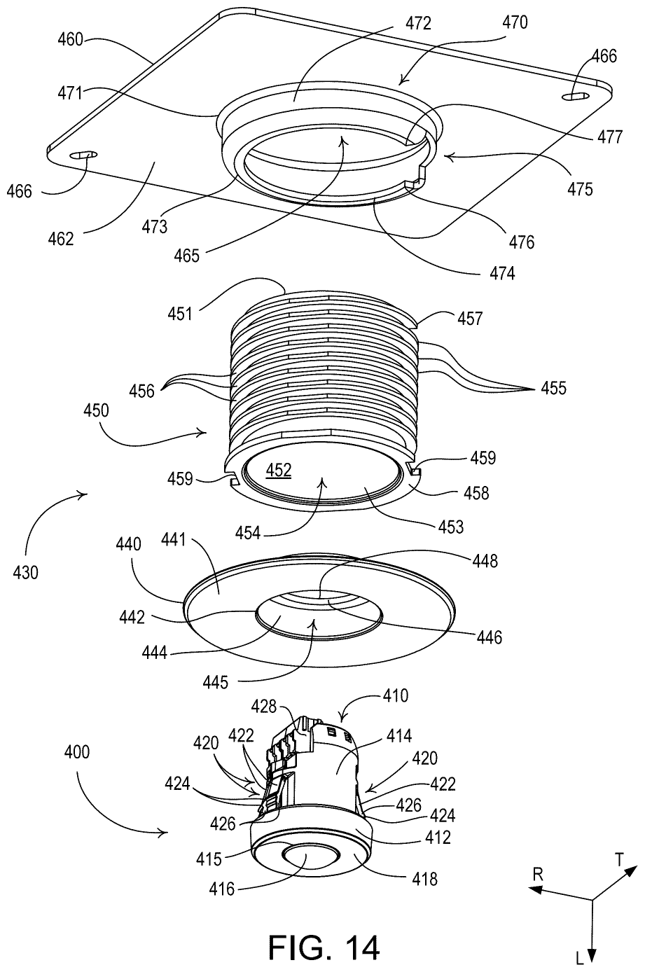

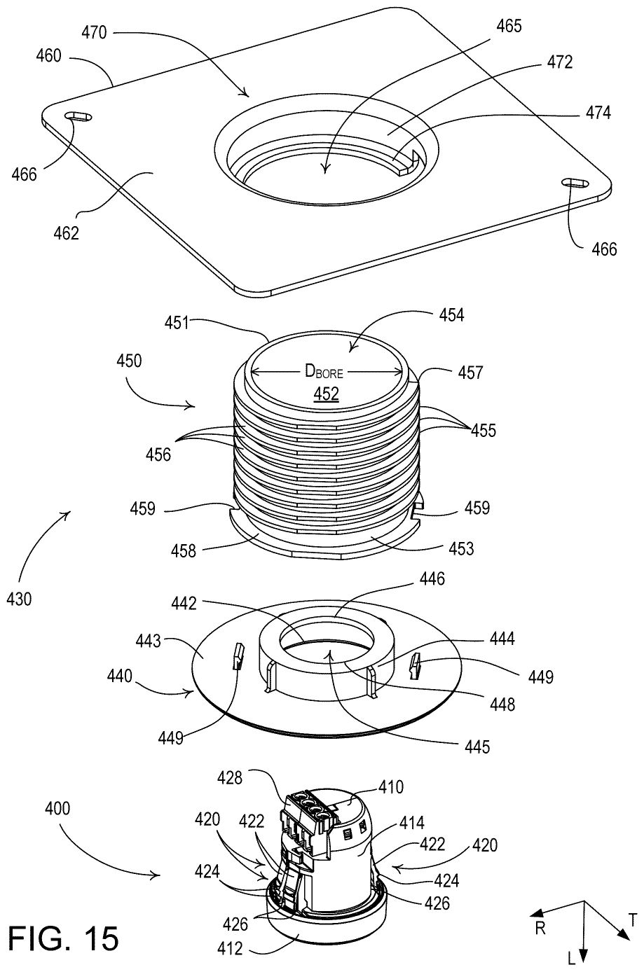

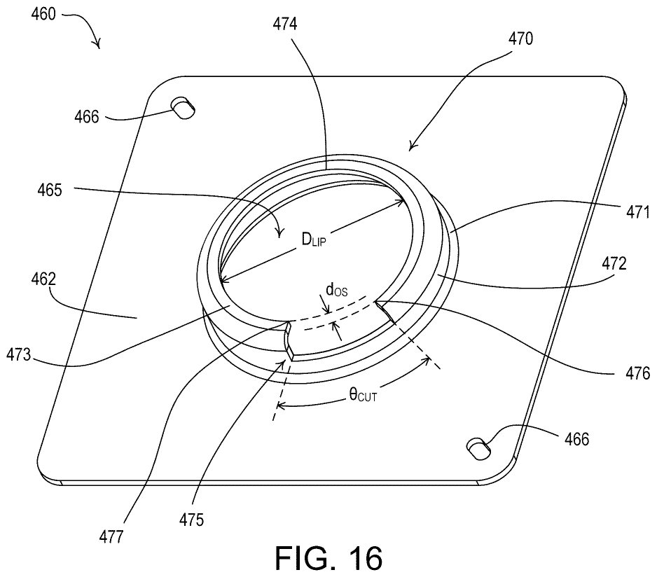

FIGS. 11-16 illustrate another example mounting assembly 430 (e.g., such as the mounting assembly 230) for mounting a control module 400 (e.g., such as the control modules 120a-120d for the load control system 100 shown in FIG. 1 and/or the control module 300 shown in FIGS. 2-5). FIG. 11 is a side cross-section view of an installation 401 including the control module 400 mounted to a ceiling 402 via the mounting assembly 430 taken through the center of the control module 400 (e.g., through the line shown in FIG. 5). FIG. 12 is a bottom exploded view and FIG. 13 is a top exploded view of the installation 401 shown in FIG. 11. FIG. 14 is an enlarged bottom exploded view and FIG. 15 is an enlarged top exploded view of the control module 400 and the mounting assembly 430. For example, the control module 400 may be identical to the control module 200 shown in FIGS. 2-5. The control module 400 may be configured to be mounted to the ceiling 402 near a lighting fixture (e.g., one of the lighting fixtures 110a-110d) and electrically connected to different types of lighting control devices, such as different types of LED drivers, for example. The control module 400 may be electrically connected to the lighting control device(s) (e.g., via a wired communication link and/or control link) to enable control of the lighting control device(s) in response to information provided from the control module 400. When the control module 400 is mounted to the ceiling 402, the mounting assembly 430 may be connected to (e.g., supported by) a structure, such as a junction box 408 that may be located above the ceiling 402. As shown in FIGS. 12 and 13, the ceiling 402 may comprise an opening 404 through which the mounting assembly 430 may extend for mounting the control module 400 to the ceiling 402 (e.g., to the junction box 408). In some examples, the mounting assembly 430 may be supported by the ceiling 402 itself (e.g., mounted to a rear surface 406 of the ceiling 402).

The control module 400 may comprise an enclosure 410 (e.g., the enclosure 410) that may include a front portion 412 (e.g., the front portion 212) and a rear portion 414 (e.g., the rear portion 214). The control module 300 may comprise a lens 416 received in an aperture 415 in a front surface 418 of the front portion 412 of the enclosure 410 (e.g., such as the lens 216 received in the aperture 215 in the front surface 218 of the front portion 212 of the enclosure 200). The lens 416 may be dome-shaped and made of at least a partially infrared or visible light transparent material to allow infrared energy to enter the enclosure 410 through the aperture 415. The control module 400 may comprise an occupancy detection circuit having a detector 419 (FIG. 11). For example, the occupancy detection circuit may comprise a passive infrared (PIR) sensing circuit, and the detector 419 may comprise a pyroelectric detector. The detector 419 may be configured to detect infrared energy from an occupant in a load control environment (e.g., such as the room 101 shown in FIG. 1) that may enter the control module 400 through the aperture 415 of the front portion 412 of the enclosure 410 (e.g., through the lens 416). The control module 400 may be configured to detect motion in the load control environment (e.g., occupancy and/or vacancy conditions) in response to the infrared energy detected by the detector 419. In addition, the control module 400 may comprise a photosensing circuit (e.g., a daylight sensor circuit) and/or another sensing circuit. In some examples, the control module 400 may not comprise any sensing circuits (e.g., the control module 400 may not include the lens 416 when the control module 400 does not include any sensing circuits).

The control module 400 may comprise a connector 428 that may allow for connection to an external power source (e.g., such as an external direct-current (DC) power source) and/or an external load control device for controlling a lighting load located in the lighting fixture (e.g., such as an LED driver for controlling an LED light source). For example, the connector 428 may comprise two electrical terminals configured to receive wires that may be connected to the power source to allow the control module 400 to receive power for powering the electrical circuitry of the control module 400. In addition, the connector 428 may comprise two electrical terminals that may receive wires that may be connected to the load control device via a wired communication link and/or a wired control link for controlling the lighting load (e.g., such as the communication links 122a-122d shown in FIG. 1).

The mounting assembly 430 may comprise a cover plate 440 (e.g., a wall plate or face plate), a coupling element 450 (e.g., a threaded tube), and a support member 460 (e.g., a mud ring). The support member 460 may comprise a plate portion 462 and a drum portion 470, which may define an opening 465 that extends through the support member 460. As shown in FIGS. 12 and 13, the support member 460 may be configured to be attached to the junction box 408. For example, the support member 460 may be secured to the junction box 408 via respective fasteners 461 (e.g., screws) received through openings 466 (e.g., slots) in the plate portion 462 of the support member 460 and screw holes 409 of the junction box 408. As shown in FIG. 11, the drum portion 470 may be configured to extend into the opening 404 of the ceiling 402.

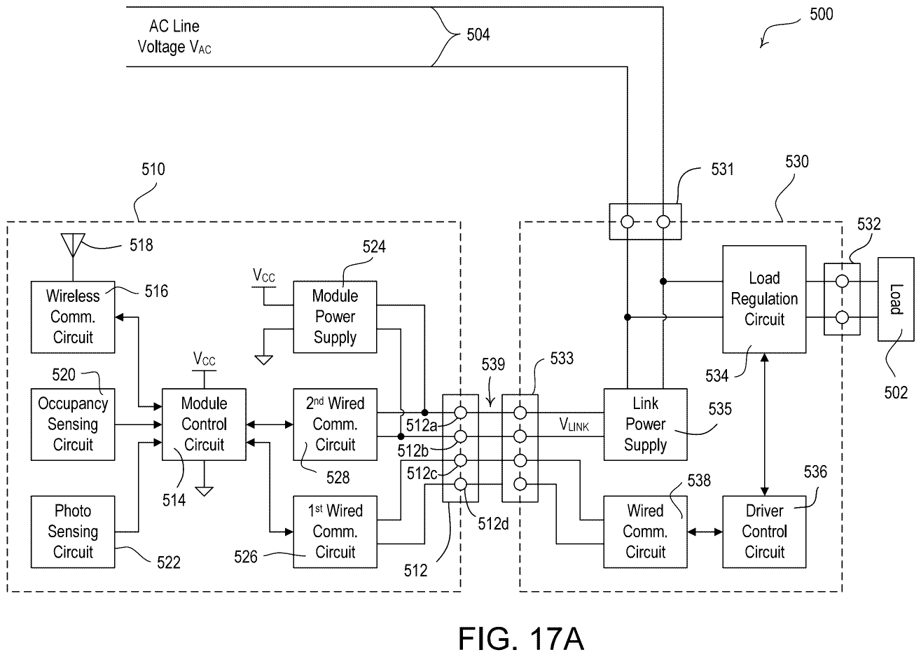

FIG. 16 is an enlarged perspective view of the support member 460. The drum portion 470 may comprise a sidewall 472 that extends from a base end 471 (e.g., that is connected to the plate portion 462) to a distal end 473. The drum portion 470 may comprise a lip 474 at the distal end 473. The lip 474 may at least partially surround the periphery (e.g., the circumference) of the drum portion 470 at the distal end 473. For example, the lip 474 may be characterized by a diameter D_{LIP} (e.g., approximately 1.56 inches). The drum portion 470 may comprise a cut-out portion 745 (e.g., a break or notch) in the lip 474 (e.g., and possibly the sidewall 472), such that the lip 474 (e.g., and possibly a portion of the sidewall 472) does not extend around the entire periphery of the drum portion 470. The lip 474 may extend from a first end 476 to a second end 477. For example, the cut-out portion 475 may be characterized by angular length θ_{CUT} (e.g., approximately 51.4 degrees). The lip 474 may define a sloped surface between the first end 476 and the second end 477 (e.g., the lip 474 may have a helical shape). The second end 477 of the lip 474 may be farther away from the plate portion 462 than the first end 476, such that the second end 477 is offset from the first end 476 by a distance d_{OS} (e.g., approximately 0.12 inches) along the longitudinal axis L.

The coupling element 450 may be configured to mechanically couple the cover plate 440 (e.g., and the control module 400) to the support member 460 of the mounting assembly 430 (e.g., and thus to the junction box 408). The coupling element 450 may comprise a body 452 (e.g., a cylindrical body or tubular body) extending from a first end 451 to a second end 453. The body 452 of the coupling element 450 may define a bore 454 (e.g., a cylindrical bore) extending therethrough (e.g., from the first end 451 to the second end 453). For example, the bore 454 may have an inner diameter D_{BORE} (FIG. 15) of approximately 1.4 inches. The coupling element 450 may further comprise a thread 455 (e.g., a helical thread) that may extend (e.g., wrap) around the body 452 multiple times in a helical shape, such that a channel 456 is formed between adjacent wraps of the thread 455. For example, the thread 455 may have a pitch of approximately 0.14 inches. The thread 455 may extend from an initial end 457 at the first end 451 of the body 452 to a terminal end (not shown) at the second end 453 of the body 452. In some examples, the thread 455 may not extend from exactly the first end 451 to the second end 453 of the body 452 (e.g., the thread 455 may only extend for a portion of the body 452). The body 452 of the coupling element 450 may further comprise a flange portion 458 (e.g., a mounting portion) extending around the bore 454 at the second end 453 of the body 452. For example, the thread 455 may terminate at the flange portion 458 (e.g., the terminal end of the thread 455 may be at the flange portion 458). In some examples, the thread 455 may not terminate at the flange portion 458, but may terminate before reaching the flange portion 458. While the coupling element 450 is shown as having a single thread 455 that winds around the body 452, in some examples, the coupling element 450 may comprise multiple segments of threads that wind around the body 452.

The body 452 of the coupling element 450 may be received within the opening 465 of the drum portion 470 of the support member 460. For example, the lip 474 of the drum portion 470 may be received in the channel 456 formed between adjacent wraps of the thread 455. To connect the coupling element 450 to the support member 460, the first end 451 of the body 452 of the coupling element 450 may be inserted into the opening 465 of the drum portion 470 of the support member 460, such that the second end 476 of the lip 474 of the drum portion 470 is received in the channel 456 of the coupling portion 450 adjacent to the initial end 457 of the thread 455. The coupling element 450 may be rotated such that the body 452 moves further into the opening 465 of the drum portion 474 of the support member 460. After the body 452 of the coupling element 450 is received in the opening 465 of the drum portion 470 of the support member 460, contact and/or friction between the lip 470 of the drum portion 470 of the support member 460 and the thread 455 of the coupling element 450 may prevent movement of the coupling element 450 in the direction of the longitudinal axis L.

The control module 400 (e.g., the rear portion 414 of the enclosure 410) may be connected to the cover plate 440 of the mounting system 430. The cover plate 440 may comprise a front surface 441 defining a front opening 442 through which the control module 400 may be received. The cover plate 440 may also comprise a sidewall 444 (e.g., a cylindrical sidewall) that extends from a rear surface 443 of the cover plate 440. The sidewall 444 may define a recess 445 that is surrounded by the front opening 442 at the front surface 441 of the cover plate 440. The sidewall 444 may extend from the rear surface 443 of the cover plate 440 to a lip 446 (e.g., a flange portion) that defines (e.g., surrounds) a rear opening 448 of the recess 445.

As shown in FIGS. 14 and 15, the rear portion 414 of the enclosure 410 of the control module 400 may comprise one or more clips 420 (e.g., such as the clips 220 shown in FIGS. 2-5) for connecting the control module 400 to the mounting assembly 430 (e.g., to the cover plate 440 of the mounting assembly 430). The clips 420 may each comprise a respective arm 422 and a plurality of teeth 424 located at an end 426 of the respective arm 422. The clips 420 may be configured to attach (e.g., snap) to the cover plate 440 of the mounting assembly 430. One or more of the teeth 424 of the clips 420 may be configured to engage the lip 446 of the cover plate 440 for mounting (e.g., locking) the control module 400 within the recess 445 of the cover plate 440 of the mounting assembly 440 (e.g., within the opening 404 in the ceiling 402). The clips 420 may be resiliently biasable, for example, towards the rear portion 414 of the enclosure 410 of the control module 400. As the control module 400 is inserted through the front opening 442 in the front surface 441 of the cover plate 440 and into the recess 445 of the cover plate 440, the arms 422 of the respective clips 420 may be configured to bend in towards the rear portion 414 of the enclosure 410 such that the teeth 424 are biased toward the rear portion 414 of the enclosure 410. The lip 446 of the cover plate 440 may press the clips 420 toward the rear portion 414 of the enclosure 410 such that the clips 420 fit within the rear opening 448 of the cover plate 440 as the control module 400 is inserted through the front opening 442 in the front surface 441 of the cover plate 440 and into recess 445 of the cover plate 440. The control module 400 may be secured in position within the recess 445 of the cover plate 440 when one or more of the teeth 424 of the clips 420 contact the lip 446 of the cover plate 440. As shown in FIG. 11, the front portion 412 of the enclosure 410 may be received within the recess 445 of the cover plate 440 such that the front surface 418 of the front portion 412 of the enclosure 410 is substantially flush with the front surface 441 of the cover plate 440. In this fashion, the front portion 412 of the enclosure 410 is recessed into the opening 404 of the ceiling 402 and the front surface 418 of the front portion 412 of the enclosure 410 is substantially flush with the front surface 405 of the ceiling 402.

The cover plate 440 may further comprise snaps 449 extending from the rear surface 443 of the cover plate 440. The snaps 449 of the cover plate 440 may be received in respective notches 459 in the flange portion 458 of the coupling element 450 for attaching the cover plate 440 and the control module 400 to the coupling element 450 and thus the support member 460. When the cover plate 440 is connected to the support member 460 via the coupling element 450, the cover plate 440 may cover the opening 404 of the ceiling 402. After the cover plate 440 is connected to the coupling element 450, the cover plate 440 may be rotated to rotate the coupling element 450 (e.g., since the snaps 449 of the cover plate 440 are received in the notches 459 of the flange portion 458 of the coupling element 450). The position of the coupling element 450 (e.g., and the cover plate 440) with respect to the support member 460 (e.g., along the longitudinal axis L) may be adjustable to account for different thicknesses of the ceiling 402. For example, the cover plate 440 may be rotated to rotate the coupling element 450 until the rear surface 443 of the cover plate 440 abuts a front surface 405 of the ceiling 402 (e.g., to adjust the position of the coupling element 450 with respect to the support member 460 depending upon the thickness of the ceiling 402). As shown in FIG. 11, the control module 400 may extend through the opening 404 in the ceiling 402 and into the junction box 408. At least a portion of the front portion 412 of the enclosure 410 of the control module 400 may be located within the opening 404 of the ceiling 402 (e.g., at least a portion of the front portion 412 may extend beyond the front surface 405 of the ceiling 402). The front portion 412 of the enclosure 410 of the control module 400 and the cover plate 440 of the mounting assembly 430 may be visible to a user when the control module 400 is installed in the ceiling 402 via the mounting assembly 430. In addition, the rear portion 414 of the enclosure 410 of the control module 400 and the opening 404 of the ceiling 402 may be hidden from view from the user when the control module 400 is installed in the ceiling 402 via the mounting assembly 430.

The wires that are connected to the control module 400 (e.g., for power and/or communication) may extend from the lighting fixture in which the load control device is located through the junction box 408 to the connector 428. Before the control device 400 and the cover plate 440 are mounted to the ceiling 402, the wires may be pulled (e.g., routed) from the lighting fixture through the junction box 408, the opening 465 of the support member 460, and the bore 454 of the coupling member 450. The control module 400 may be connected to (e.g., snapped onto) the cover plate 440. The wires may then be connected to the connector 428 of the control module 400 and the cover plate 440 may be connected to (e.g., snapped onto) the coupling portion 450 to mount the control module 400 to the ceiling 402.

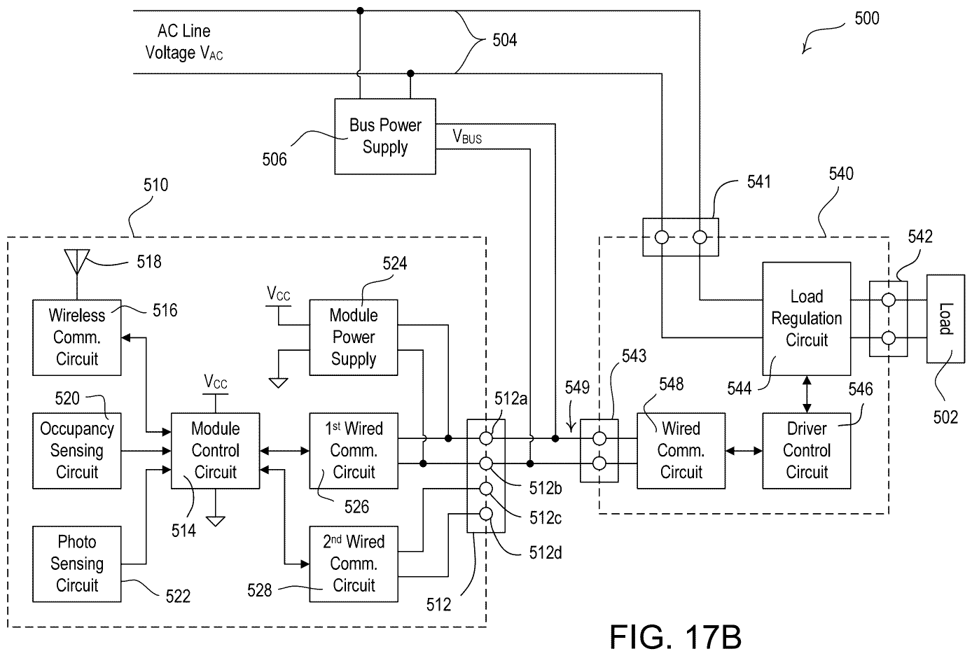

FIGS. 17A and 17B are block diagrams of an example load control system 500 in first and second configurations, respectively. The load control system 500 may comprise a control module 510 (e.g., a sensor device), which may be deployed as the control modules 120a-120d of the load control system 100 shown in FIG. 1, the control module 200 shown in FIGS. 2-5, the control module 300 shown in FIGS. 6-10, and/or the control module 400 shown in FIGS. 11-15. In addition, the load control system 500 may comprise a first load regulation device, such as a first lighting control device 530, in the first configuration (e.g., as shown in FIG. 17A) and a second load regulation device, such as a second lighting control device 540, in the second configuration (e.g., as shown in FIG. 17B). The first and second lighting control devices 530, 540 may be LED drivers and may be examples of the lighting control devices of the lighting control devices of the lighting fixtures 110a-110d of the load control system 100 of FIG. 1. The first and second lighting control devices 530, 540 may be electrically coupled to an alternating-current (AC) power source (not shown) via power wires 504 for receiving an AC mains lines voltage V_{AC} from the AC power source. The first and second lighting control devices 530, 540 may each be configured to control an amount of power delivered from the AC power source to an electrical load, such as a lighting load 502 (e.g., an LED light source). The lighting load 502 and the control module 510 may be configured to be installed (e.g., in a ceiling) near a lighting fixture (e.g., one of the lighting fixtures 110a-110d shown in FIG. 1) along with the first lighting control device 530 in the first configuration and the second lighting control device 540 in the second configuration.

The control module 510 may comprise a control connector 512 (e.g., the connector 228, the connector 328, and/or the connector 428) configured to be electrically connected to the first lighting control device 530 in the first configuration and the second lighting control device 540 in the second configuration. For example, the module connector 512 of the control module 510 may comprise four electrical terminals. The control module 510 may be configured to receive power via the control connector 512 for powering the electrical circuitry of the control module 510. The control module 510 may also be coupled to the first lighting control device 530 and/or the second lighting control device 540 via the control connector 512.

The control module 510 may comprise a module control circuit 514 for controlling the operation of the control module 510. For example, the module control circuit 514 may comprise one or more of a processor (e.g., a microprocessor), a microcontroller, a programmable logic device (PLD), a field programmable gate array (FPGA), an application specific integrated circuit (ASIC), or any suitable controller or processing device. The control module 510 may also include a memory (not shown). The memory may be communicatively coupled to the module control circuit 514 for the storage and/or retrieval of, for example, operational settings of the control module 510. In addition, the memory may be configured to store software for execution by the module control circuit 514 to operate the control module 510. The memory may be implemented as an external integrated circuit (IC) and/or as an internal circuit of the module control circuit 514.

The control module 510 may comprise a wireless communication circuit 516 configured to communicate with control devices of the load control system via wireless signals, such as RF signals (e.g., the RF signals 104, 105 shown in FIG. 1). The wireless communication circuit 516 may include for example, one or more radio-frequency (RF) transceivers coupled to an antenna 518 (e.g., the antenna 280) for communicating (e.g., transmitting and/or receiving) the RF signals. The wireless communication circuit 516 may also include one or more of an RF transmitter for transmitting RF signals and/or an RF receiver for receiving RF signals. The wireless communication circuit 516 may be configured to communicate (e.g., transmit and/or receive) messages (e.g., digital messages) via the RF signals. For example, the wireless communication circuit 516 may be configured to transmit and/or receive messages on a first wireless communication link using a first wireless protocol (e.g., via the RF signals 104 on the wireless network communication link using the wireless network communication protocol), and on a second wireless communication link using a second wireless protocol (e.g., via the RF signals 105 on the short-range wireless communication link using the short-range wireless communication protocol). For example, the wireless communication circuit 516 may comprise a single RF transceiver configured to communicate on the wireless network communication link and the short-range wireless communication link, or multiple (e.g., two) RF transceivers, such as a first RF transceiver for communicating on the wireless network communication link and a second RF transceiver for communicating on the short-range wireless communication link. The messages received by the module control circuit 514 via the RF signals may include configuration data for configuring the control module 510 and/or control data (e.g., commands) for controlling the lighting load 502. The configuration data and/or control data may include identification information (e.g., such as a unique identifier) associated with the control module 510. While shown separately from the module control circuit 514 in FIGS. 17A and 17B, the wireless communication circuit 516 may also be implemented as an internal circuit of the module control circuit 514.

The control module 510 may comprise an occupancy sensing circuit 520 configured to sense (e.g., detect) an occupancy and/or vacancy condition in the vicinity of the lighting fixture in which the control module 510 is installed (e.g., in the room 101). The occupancy sensing circuit 520 may comprise a detector for detecting an occupancy and/or vacancy condition in the space. For example, the occupancy sensing circuit 520 may comprise a passive infrared (PIR) sensing circuit, where the detector is a pyroelectric detector. In addition, the detector may comprise one or more of an ultrasonic detector, and/or a microwave detector. For example, a pyroelectric detector may be configured to receive infrared energy from an occupant in the space below the control module 510 (e.g., below the lighting fixture) through a lens (e.g., the lens 216, the lens 318, and/or the lens 418) to thus sense the occupancy condition in the space. The module control circuit 514 may be configured to determine a vacancy condition in the space after a timeout period expires since the last occupancy condition was detected. The module control circuit 514 may be configured to control the first and/or second lighting control device 530, 540 to turn the lighting load 502 on and off and to adjust the intensity level of the lighting load 502 in response to the occupancy sensing circuit 520 detecting occupancy and/or vacancy conditions.

The control module 510 may further comprise a photo-sensing circuit 522 configured to measure a light level (e.g., an ambient light level and/or a daylight level) in the vicinity of the lighting fixture in which the control module 510 is installed (e.g., in the room 101). The photo-sensing circuit 522 may comprise a photosensor (e.g., the detector 319 and/or the detector 419) for measuring the light level in the space. For example, the photosensor may be configured to receive light from the space below the control module 510 (e.g., below the lighting fixture) through the lens to thus measure the light level in the space. The module control circuit 514 may be configured to control the first and/or second lighting control device 530, 540 to turn the lighting load 502 on and off and to adjust the intensity level of the lighting load 502 in response to the light level measured by the photo-sensing circuit 522.

The control module 510 may have one or more circuits coupled to the control connector 512 for receiving power and/or controlling the first and/or second lighting control devices 530, 540 (e.g., depending on whether the load control system 500 is in the first configuration or the second configuration as will be described in greater detail below). The control module 510 may comprise a module power supply 524 (e.g., an internal power supply) configured to receive power via the electrical terminals 512a, 512b of the control connector 512 and generate a direct-current (DC) module supply voltage V_{CC} for powering the module control circuit 514, the wireless communication circuit 516, the occupancy sensing circuit 520, the photo-sensing circuit 522, and/or other electrical circuitry of the control module. The control module 510 may comprise a first wired communication circuit 526 which may be coupled to two electrical terminals 512c, 512d of the control connector 512 and may be used to communicate with the first lighting control device 530 in the first configuration. The control module 510 may comprise a second wired communication circuit 528 which may be coupled to the electrical terminals 512a, 512b of the control connector 512 and may be used to communicate with the second lighting control device 540 in the second configuration.

When the load control system 500 is in the first configuration as shown in FIG. 17A, the control module 510 may be coupled to the first lighting control device 530 via a four-wire control link 539. The first lighting control device 530 may comprise a power connector 531 configured to be electrically coupled to the AC power source via the power wires 504 for receiving the AC mains lines voltage V_{AC} and a load connector 532 configured to be electrically coupled to the lighting load 502. The first lighting control device 530 may also comprise a control connector 533 that may be configured to be electrically coupled to the control module 510 via the four-wire control link 539. For example, the control connector 533 of the first lighting control device 530 may comprise four electrical terminals as shown in FIG. 17A.

The first lighting control device 530 may comprise a load regulation circuit 534 (e.g., an LED drive circuit) that may be coupled between the power connector 531 and the load connector 532 and may be configured to control the amount of power delivered to the lighting load 502. The first lighting control device 530 may comprise a link power supply 535 coupled to receive the AC mains line voltage V_{AC} via the power connector 531 and generate a link supply voltage V_{LINK} for powering the control module 510 via the control connector 533. The module power supply 524 of the control module 510 may receive the link supply voltage V_{LINK} via the electrical terminals 512a, 512b of the control connector 512.

The first lighting control device 530 may comprise a driver control circuit 536 configured to control the load regulation circuit 534 to adjust the amount of power delivered to the lighting load 502 to adjust an intensity level of the lighting load. The first lighting control device 530 may further comprise a wired communication circuit 538 configured to be coupled to the control module 510 via the control connector 533 (e.g., the four-wire control link 539). The wired communication circuit 538 of the first lighting control device 530 may be coupled to the first wired communication circuit 526 of the control module 510 via the electrical terminals 512c, 512d of the control connector 512. The first wired communication circuit 526 of the control module 510 may be configured to generate, for example, an analog control signal, such as a 0-10V control signal, at the electrical terminals 512c, 512d of the control connector 512. For example, the first wired communication circuit 526 of the control module 510 may comprise a current sink circuit configured to draw current from the wired communication circuit 538 of the first lighting control device 530 to generate the 0-10V control signal at the electrical terminals 512 c, 512 d of the control connector 512. The driver control circuit 536 of the first lighting control device 530 may be configured to adjust the intensity level of the lighting load 502 in response to a magnitude of the analog control signal received by the wired communication circuit 538. Alternatively or additionally, the first wired communication circuit 526 of the control module 510 may be configured to transmit messages (e.g., digital messages) to the wired communication circuit 538 of the first lighting control device 530 according to a digital communication protocol. For example, the first wired communication circuit 526 of the control module 510 and the wired communication circuit 538 of the first lighting control device 530 may comprise RS-485 communication circuits. The driver control circuit 536 of the first lighting control device 530 may be configured to adjust the intensity level of the lighting load 502 in response to control data (e.g., commands) included in the messages received by the wired communication circuit 538. When the control module 510 is wired to the first lighting control device 530 in the first configuration, the module control circuit 514 of the control module 510 may be configured to disable the second wired communication circuit 528.

When the load control system 500 is in the second configuration as shown in FIG. 17B, the control module 510 may be coupled to the second lighting control device 540 via a two-wire control link 549. The second lighting control device 540 may comprise a power connector 541 configured to be electrically coupled to the AC power source via the power wires 504 for receiving the AC mains lines voltage V_{AC} and a load connector 542 configured to be electrically coupled to the lighting load 502. The second lighting control device 540 may also comprise a control connector 543 that may be configured to be electrically coupled to the control module 510 via the two-wire control link 549. For example, the control connector 543 of the first lighting control device 540 may comprise two electrical terminals as shown in FIG. 17B.

The second lighting control device 540 may comprise a load regulation circuit 544 (e.g., an LED drive circuit) that may be coupled between the power connector 541 and the load connector 542 and may be configured to control the amount of power delivered to the lighting load 502. The second lighting control device 540 may comprise a driver control circuit 546 configured to control the load regulation circuit 544 to adjust the amount of power delivered to the lighting load 502 to adjust the intensity level of the lighting load. The second lighting control device 540 may further comprise a wired communication circuit 548 configured to be coupled to the control module 510 via the control connector 543 (e.g., the two-wire control link 539). The wired communication circuit 548 of the second lighting control device 540 may be coupled to the first wired communication circuit 528 of the control module 510 via the electrical terminals 512a, 512b of the control connector 512. The second wired communication circuit 528 of the control module 510 may be configured to transmit messages (e.g., digital messages) to the wired communication circuit 548 of the first lighting control device 540 according to a digital communication protocol, e.g., such as the Digital Lighting Control Interface (DALI) protocol. The driver control circuit 546 of the second lighting control device 540 may be configured to adjust the intensity level of the lighting load 502 in response to control data (e.g., commands) included in the messages received by the wired communication circuit 548.

In the second configuration, the control module 510 may be configured to receive power from the two-wire control link 549 via the electrical terminals 512a, 512b of the control connector 512 (e.g., the two-wire control link 549 may be a dual-purpose power and communication link), and the electrical terminals 512c, 512d of the control connector 512 may remain unconnected. The second lighting control device 540 may not comprise a link power supply for powering the control module 510. For example, the lighting control system 500 may comprise a bus power supply 506 in the second configuration. The bus power supply 506 may be configured to receive the AC mains line voltage V_{AC} from the AC power source and generate a bus voltage V_{BUS}, which may be electrically coupled to the two-wire control link 549 (e.g., the electrical terminals 512a, 512b of the control connector 512) to provide for communications on the two-wire control link 549 as well as to power the control module 510. The bus power supply 506 may be external to the lighting fixture near which the control module 510 is installed and/or may be included in the lighting fixture near which the control module 510 is installed. The module power supply 524 of the control module 510 may receive the bus voltage V_{BUS} via the electrical terminals 512a, 512b of the control connector 512 (e.g., when the first wired communication circuit 528 of the control module 510 and/or the wired communication circuit 548 of the second lighting control device 540 are not transmitting messages on the two-wire control link 549). Additionally and/or alternatively, the bus power supply 506 may be included in the second lighting control device 540.

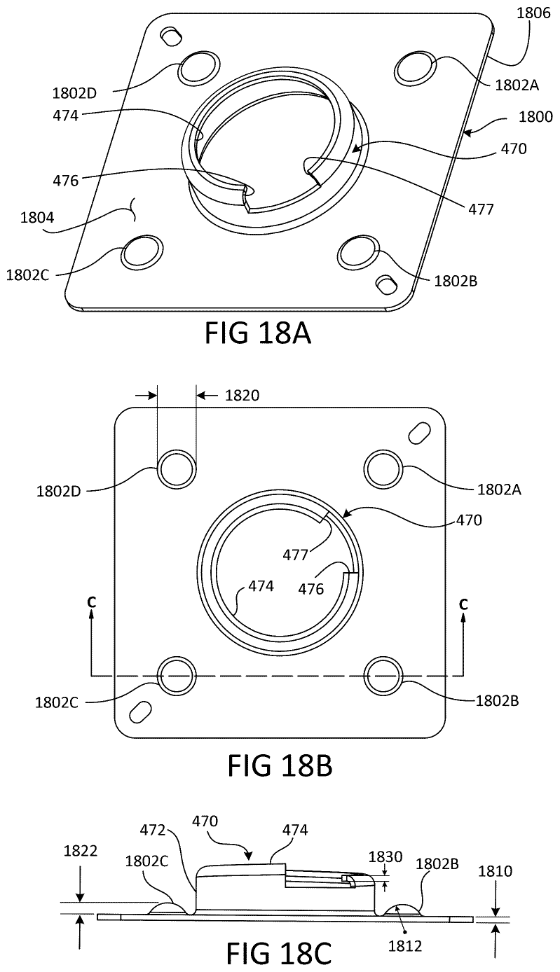

FIGS. 18A, 18B, and 18C depict another illustrative support member 1800 that includes a plurality of bumps 1802A-1802n (collectively, “bumps 1802”) Four such bumps, 1802A-1802D, are depicted in FIGS. 18A-18D) that extend from a lower surface 1804 of support member 1800. The drum portion 470 of support member 1800 also extends from the lower surface 1804 of support member 1800. The drum portion 470 includes a sidewall 472 having a distal end forming a lip 474 having a thickness 1830.

The bumps 1802 provide a fixed distance between the lower surface 1804 of support member 1800 and the surface upon which the support member 1800 is mounted, such as an upper surface of a ceiling. Maintaining a consistent distance between the lower surface 1804 of the support member 1800 and the mounting surface beneficially improves the uniformity of the projection of a sensor array coupled to the drum portion 470 with respect to the mounting surface to which the support member 1800 is mounted. Further, when installed the bumps 1802 contact the mounting surface, causing the support member 1800 to contact the support surface in a near uniform manner, thereby beneficially limiting or eliminating any unevenness or skewing of the support member 1800 with respect to the mounting surface.

Although bumps 1802 are depicted as hemispherical in FIGS. 18A-18C, bumps 1802 may have any geometric shape including, but not limited to: ovoid, pyramidal, cylindrical, polygonal, or random shapes. The bumps 1802 may be uniformly or randomly distributed or otherwise disposed on the lower surface 1804 of the support member 1800. The bumps 1802 can have a similar geometric configuration (e.g., hemispheres) or may include a mix of geometric configurations (e.g., hemispheres and cylinders). Each of the bumps 1802 has a similar projection 1820 with reference to the lower surface 1804 of the support member 1800. Support member 1800 may be fabricated using any metallic material, any non-metallic material, or any combination thereof. Example metallic materials include but are not limited to: steel, galvanized steel, painted steel, aluminum, or aluminum alloys. Example non-metallic materials include but are not limited to: polystyrene or carbon fiber. The support member 1800 is fabricated using a material having a thickness 1810. For example, the support member 1800 may be fabricated from a metallic material (e.g., aluminum) having a thickness 1810 of: about 0.050 inches (16 ga.) or less; about 0.100 inches or less (10 ga.); about 0.129 inches (8 ga.) or less; or about 0.250 inches or less.

In embodiments, each of the bumps 1802 has a uniform projection 1820 measured with respect to the lower surface 1804 of the support member 1800. In other embodiments, some or all of the bumps 1802 have a non-uniform projection 1820 measured with respect to the lower surface 1804 of the support member 1800. For example, bumps 1802 may have a projection 1820 of: about 0.125 inches or less; about 0.250 inches or less; or about 0.500 inches or less measured with respect to the lower surface of support member 460. In embodiments, each of the bumps 1802 has a uniform diameter 1822. In other embodiments, some or all of the bumps 1802 may have different diameters 1822. For example, bumps 1822 may have a diameter of: about 0.125 inches or less; about 0.250 inches or less; about 0.500 inches or less; about 0.750 inches or less; or about 1.000 inches or less. In embodiments, bumps 1802 may include hemispherical or semi-hemispherical surfaces having a uniform or similar radius of curvature 1812. For example, bumps 1802 may a hemispherical surface having a uniform or similar radius of curvature 1812 of: about 0.750 inches or less; about 1.000 inches or less; about 1.500 inches or less; about 2.000 inches or less; or about 3.000 inches or less.

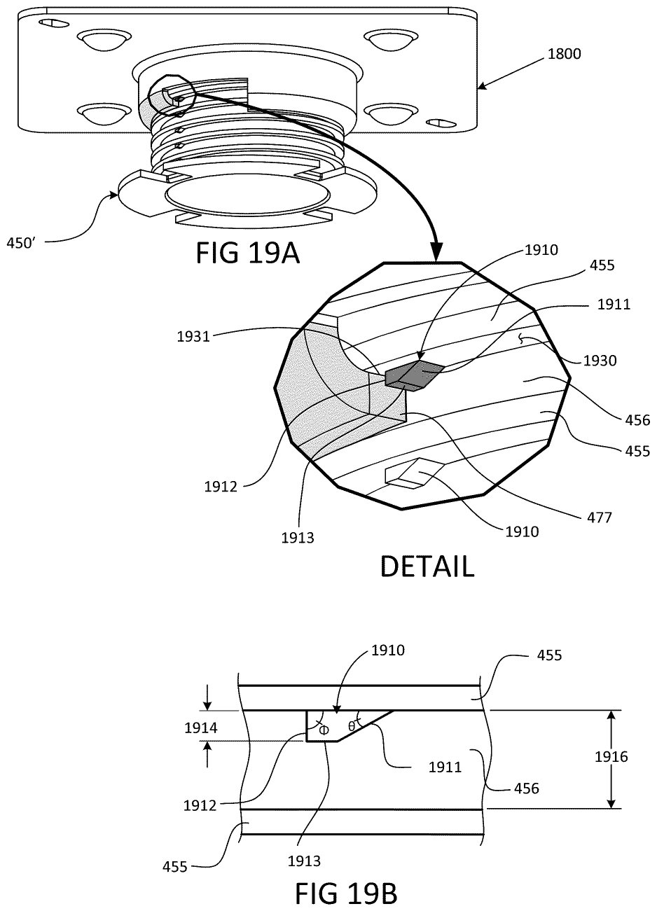

FIGS. 19A and 19B depict a coupling element 450′ that includes an illustrative locking or anti-backout feature that includes a ramp structure 1910 formed integral with, attached to, or incorporated into a lower surface 1930 of at least some of the threads 455 of the coupling element 450′. Coupling element 450′ includes one or more anti-backout features to prevent the possibility of coupling element 450′ from counter-rotating and backing-out of the support member 1800. Over time, structural vibration may cause the coupling element 450′ to back out and potentially disengage from the lip 474 of drum portion 470. Although the following discussion is based on a coupling element 450 having right-hand threads (i.e., clockwise rotation to insert the coupling element 450′ into the drum portion 470), one of ordinary skill in the art will readily understand that other thread patterns such as left-hand threads (i.e., anti-clockwise rotation to insert the coupling element 450′ into the drum portion 470) may also be used with equal performance and effectiveness.

The coupling element 450′ can be used in conjunction with any of the embodiments described herein. Each of the ramp structures 1910 permits the clockwise rotation (i.e., insertion) of the coupling element 450′ into the drum portion 470 of support member 1800 and inhibits the anti-clockwise or counter-clockwise (i.e., removal) of the coupling element 450′ from the drum portion 470. The coupling element 450′ may have any number of ramp structures 1910 included in one or more threads 455 that wrap about the coupling element 450′. The coupling element 450′ may include any number of ramp structures 1910 in each turn of the thread 455. For example, in some embodiments coupling element 450′ includes four (4) ramp structures 1910, one each positioned at 0°, 90°, 180°, and 270° on each of at least some of the threads 455. In other embodiments, coupling element 450′ includes a single ramp structure 1910 positioned at 0° (i.e., in vertical alignment along the coupling element 450′) on each of one or more threads 455.

Each of the ramp structures 1910 includes an inclined surface portion 1911 (e.g., inclined relative to a horizontal ceiling) and a vertical surface portion 1912 (e.g., vertical relative to a horizontal ceiling). As depicted in FIG. 19B, each of the ramp structures 1910 has a height 1914 which, in some embodiments such as depicted in FIGS. 19A and 19B is measured to a planar or generally flat upper surface 1913 of the ramp structure 1910 that is parallel to the surface to which the support member 1800 is mounted. In other embodiments, the inclined surface portion 1911 and the vertical surface portion 1912 may intersect at an apex and the generally flat upper surface 1913 of the ramp structure 1910 may be omitted.

Upon engaging the threads 455 of coupling element 450′ with the thread 455 formed on drum portion 470 (i.e., rotating the coupling element 450′ in a first direction), the inclined surface portion 1911 of each ramp structure 1910 rides, slides, or is otherwise moveable or smoothly displaceable over the first end 477 of the lip 474 of drum portion 470. Thus, upon insertion, coupling element 450′ smoothly rotates with respect to the drum portion 470 of support member 1800. In installations that experience vibration or similar movement, the coupling element 450′ may, over time, begin to counter-rotate or back out (i.e., rotate in a second direction opposite the first direction used to install coupling element 450′ into support member 1800) of the drum portion 470. Left unchecked, such counter-rotation of the coupling element 450′ may cause the coupling element 450′ and any sensor array attached thereto to decouple from support member 1800. The ramp structure 1910 included in one or more threads 455 of the coupling element 450′ beneficially reduces or even eliminates the ability of the coupling element 450′ to counter-rotate or back out of the drum portion 470. The weight of the coupling element 450′ and any device or sensor attached thereto causes the lower surface 1930 of each thread 455 to contact the upper surface 1931 of the lip 474 as shown in FIG. 19A, DETAIL. In installations that experience vibration sufficient to cause counter-rotation of the coupling element 450′, as the coupling element 450′ counter-rotates with the respect to drum portion 470, the vertical surface portion 1912 of ramp structure 1910 will contact the second end 477 of the lip 474 as illustrated in FIG. 19A, DETAIL. The contact between the vertical surface portion 1912 of ramp structure 1910 prevents further counter-rotation of the coupling element 450′ thereby preventing disengagement of the coupling element 450′ from the drum portion 470 due to vibration or similar incidental forces applied to the support member 460.

Each ramp structure 1910 includes at least the inclined surface portion 1911 and the vertical surface portion 1912. In some implementations, such as illustrated in FIGS. 19A and 19B, the inclined surface portion 1911 and the vertical surface portion 1912 join the generally flat upper surface 1913 that is parallel to the lower surface 1930 of thread 455. In other embodiments, the generally flat upper surface 1913 is not needed and the inclined surface portion 1911 can directly intersect the vertical surface portion 1912. The vertical surface portion 1912 of the ramp structure 1910 has a height 1914. The inclined surface portion 1911 of the ramp structure 1910 forms a first angle (θ) with respect to the lower surface 1930 of the thread 455. For example, the first angle (θ) between the inclined surface portion 1911 of the ramp structure 620 and the lower surface 1930 of thread 455 can be: about 10° or less; about 20° or less; about 30° or less; or about 45° or less. The vertical surface portion 1912 of the ramp structure 1910 forms a second angle (Φ) with respect to the lower surface of the thread 455. For example, the second angle (Φ)formed by the vertical surface portion 612 of the ramp structure 620 and the lower surface of the thread 455 can be: about 90° or less; about 80° or less; or about 70° or less, measured with respect to.

Consecutive threads, 455n, 455n+1 form a channel 456 having a width 1916 defined by the distance (or gap) between the consecutive threads 455n, 455n+1. The lip 474 of drum portion 470 has a thickness 1830 that is less than the width 1916 of the channel 456 formed by consecutive threads 455n, 455n+1, thereby permitting the threaded attachment of the coupling element 450′ to the drum portion 470. The height 1914 of the ramp structure 1910 is less than the difference between the width 1916 of channel 456 and the thickness 1830 of lip 474. Stated differently, if the width 1914 of channel 456 is “A” and the thickness 1830 of lip 474 is “B” then the height 624 of the ramp structure 620 is less than the difference of “A” minus “B.” Beneficially, in order to remove coupling element 450′ from support member 460, application of an upward force on the coupling element 450′ may be applied while rotating the coupling element 450′ in an anti-clockwise direction. This causes the vertical surface portion 1912 to pass through the gap between the lower surface 1930 of thread 455 and the upper edge of the second end 477 of the lip 474, thereby permitting the selective removal or disengagement of the coupling element 450′ from the support member 460.

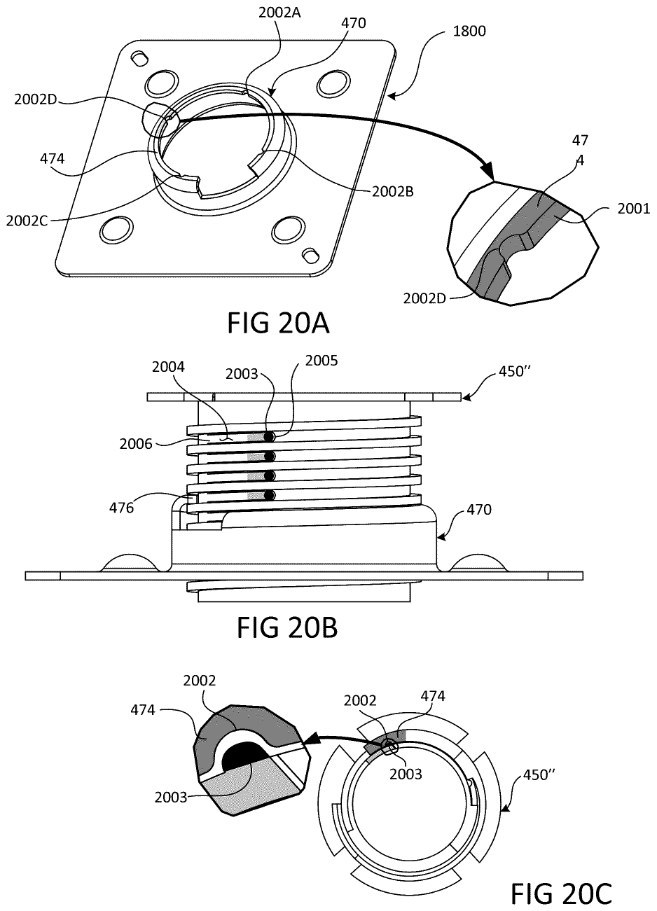

FIGS. 20A, 20B, and 20C depict another illustrative anti-backout feature 610 that includes a one or more notches 2002A-2002n (collectively, “notches 2002”, singular “notch 2002”; four (4) notches 2002A-2002D depicted in FIG. 20A) formed in an edge 2001 of lip 474 of the drum portion 470 and one or more protrusions 2003 disposed on a floating end 2005 of a spring arm 2004 formed integral with, attached to, or incorporated into one or more channels 456 formed between consecutive threads 455n, 455n+1 of coupling element 450′′. Although depicted in FIG. 20C as a hemisphere, protrusion 2003 can have any geometric form or geometric shape. For example, protrusion 2003 can include ovoid or polygonal shaped protrusions. Spring arm 2004 includes a fixed first end 2006 coupled, formed, or otherwise attached to the channel 456 and a free-floating second end 2005 that is not coupled, formed, or otherwise attached to the channel 456. The spring arm 2004 exerts a radially outward force on the free-floating end 2005 of the spring arm 2004, causing the protrusion 2003 into contact with the edge 2001 of the lip 474 of the drum portion 470.

The fixed first end 2006 of spring arm 2004 is positioned such that the fixed first end 2006 passes by the first end 476 of lip 474 prior to the free-floating second end 2005 of spring arm 2004. The spring arm 2004 forces the protrusion 2003 to contact the edge 2001 of the lip 474. As the coupling element 450′′ is rotated in a first (e.g., clockwise) direction to engage the drum portion 470, the spring arm 2004 forces the protrusion 2003 into the notches 2002 formed in the edge 2001 of the lip 474. However, with application of a rotational force to the coupling element 450″ in the first (e.g., clockwise) direction, the spring arm 2004 flexes allowing the protrusion 2003 to slip out of the notch 2002 and the continued insertion of the coupling element 450′′ into the drum portion 470.

The one or more notches 2002 formed in the edge 2001 of the lip 474 engage protrusion 2003 as the coupling element 450′′ is rotated. In some embodiments, the notches 2002 may include a plurality of detents, gaps, or similar void spaces disposed evenly or unevenly about the edge 2001 of lip 474. The force applied by the spring arm 2004 to the floating end 2005 and the protrusion 2003 beneficially permit the clockwise rotation and threaded attachment of the coupling element 450″ with less force than the anti-clockwise rotation and removal of the coupling element 450. The engagement of the protrusion 2003 with the notch 2002 caused by the radial force applied to by the spring arm 2004 reduces the possibility of inadvertent loosening and potential detachment of the coupling element 450″ from the drum portion 470 due to the rotational force required to disengage the protrusion 2003 from the notch 2002. In some embodiments, the protrusions 2003 may not engage with any notches 2002, instead, the protrusions 2003 may simply interfere with the edge 2001 of the lip 474 to create friction which prevents the coupling element 450″ from backing out. Advantageously, application of sufficient rotational force (e.g., deliberate application of rotational force by service personnel) will overcome the force exerted by the spring arm 2004 causing the retention of the protrusion 2003 in the notch 2002 thereby permitting the rotation and removal of the coupling element 450″ from the drum portion 470.

In an alternate embodiment not shown in FIGS. 20A, 20B, or 20C the edge 2001 of the lip 474 may include one or more projecting surface features that interfere, contact, or otherwise engage the protrusion 2003 disposed in channel 456 as the coupling element 450″ is rotated. In some embodiments, the one or more projecting surface features may include a plurality of projecting surface features disposed evenly or unevenly about the edge 2001 of lip 474. As the coupling element 450′′ rotates, the projecting surface features on the edge 2022 of the lip 474 will interfere with the rotation of the coupling element 450″. This interference requires application of sufficient rotational force to the coupling element 450″ to overcome the interference. Thus, the interference between the protrusion 2002 and the one or more projecting surface features on the edge 2001 of lip 474 prevents the inadvertent backing-out of the coupling element 450″ due to vibration, etc. (i.e., instances where rotational force on coupling element 450″ is minimal or non-existent) while beneficially permitting the clockwise rotation and insertion and threaded attachment of the coupling element 450′′ by installation or service personnel capable of applying sufficient rotational force to the coupling element 450″.

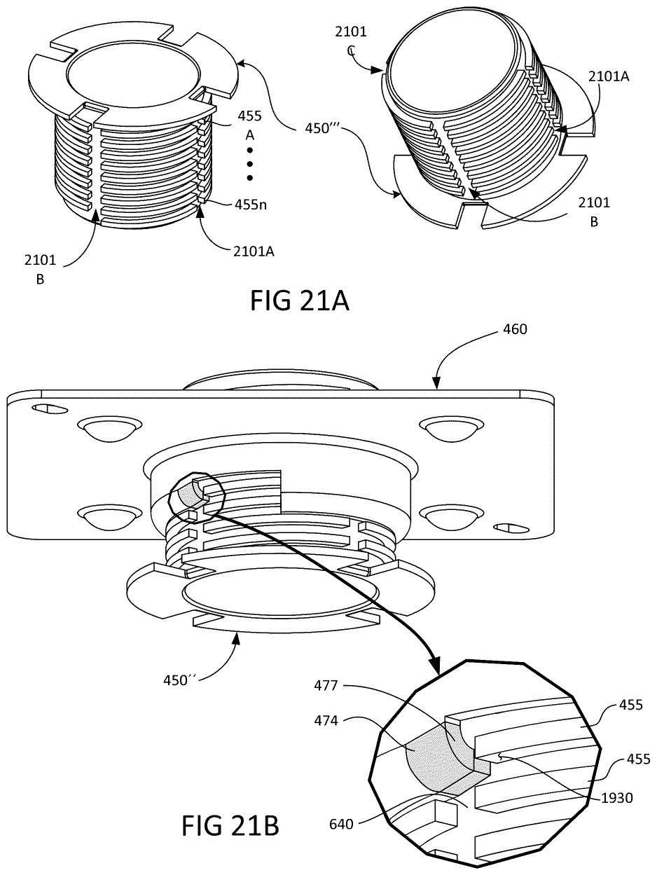

FIGS. 21A and 21B depict yet another illustrative coupling element 450′″ that includes a plurality of gaps 2101A-2101n (collectively, “gaps 2101,” singularly “gap 2101”; three (3) gaps 2101A-2101C are visible in FIGS. 21A and 21B) formed integral with or incorporated into some or all of the threads 455A-455n disposed on the external surface of coupling element 450′″. Application of an upward force on the coupling element 450′″ while rotating the coupling element 450′″ in a first (e.g., clockwise) direction prevents both the first end 476 and the second end 477 of the lip 474 from engaging, impacting, or otherwise interfering with the gaps 2101. Once installed, the weight of the coupling element 450′″ and any devices attached thereto causes the second end 477 of the lip 474 to engage, impact, or otherwise interfere with the gaps 2101.

Although not illustrated, other backout protection features to prevent the inadvertent disengagement of the coupling element 450 from the support member 460 may be used. For example, in some implementations one or more of the threads 455 on the coupling element 450 may be distorted, deformed, or otherwise deviate from the helical pattern typically found on a threaded device. In such instances thread deformations on the coupling element 450 cause friction between the coupling element 450 and the lip 474 of the drum portion 470. The friction created is sufficient to impair, inhibit, or prevent counter-rotation of the coupling element 450 caused by vibration or similar incidental forces applied to the support member 460 thereby reducing the likelihood of the coupling element backing out of the drum portion 470.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A mounting assembly for mounting a control module to a ceiling, the control module comprising an enclosure having a front portion and a rear portion, the ceiling defining an opening extending therethrough, the mounting assembly comprising:
a support structure configured to be located above the ceiling, the support structure having a drum portion;
a coupling element configured to be connected to the drum portion of the support structure and to at least partially extend into the opening of the ceiling; and
a cover plate having a front surface and defining a recess through which the control module may extend such that the front portion of the control module is received in the recess;
wherein the cover plate is configured to be attached to the coupling element such that the control module extends through the opening of the ceiling and the front portion of the control module is at least partially located within the opening of the ceiling.

2. The mounting assembly of claim 1, wherein the coupling element comprises a threaded tube configured to be received in an opening of a drum portion of the support element.

3. The mounting assembly of claim 2, wherein the coupling element comprises a body and a thread extending around the body to form a channel between consecutive wraps of the thread, and the mounting structure comprises a drum portion having a lip extending partially around the drum portion, the lip configured to be received in the channel formed between the consecutive wraps of the thread of the coupling element.

4. The mounting assembly of claim 3, wherein the coupling element comprises a mounting portion to which the cover plate may be connected.

5. The mounting assembly of claim 3, wherein the thread has a helical shape around the body of the coupling element and the lip of the support structure comprises a sloped surface having a helical shape.

6. The mounting assembly of claim 1, wherein the coupling element comprises a mounting plate configured to be connected to the support member via one or more fasteners.

7. The mounting assembly of claim 3 wherein at least a portion of the wraps of the thread include a structure that includes an inclined portion and a vertical portion, the structure extending from a lower surface of at least one of the wraps of the thread.

8. The mounting assembly of claim 3 wherein at least one channel formed by consecutive wraps of the thread includes a protrusion disposed on an end of a spring arm disposed in the channel formed by the consecutive threads.

9. The mounting assembly of claim 8 wherein the spring arm comprises a first, fixed, end attached to the channel formed by the consecutive threads and a second, floating, end not attached to the channel.

10. The mounting assembly of claim 9:
wherein the protrusion is disposed proximate the second, floating, end of the spring arm; and
wherein the second, floating, end of the spring arm exerts a radially outward force on the protrusion.

11. The mounting assembly of claim 10 wherein the lip of the drum portion includes one or more notches to receive the protrusion disposed on the floating end of the arm.

12. The mounting assembly of claim 10 wherein the lip of the drum portion includes one or more projecting surface features to contact the protrusion disposed on the floating end of the arm.

13. The mounting assembly of claim 3 wherein at least one of the wraps of the thread includes a gap formed therein.

14. The mounting assembly of claim 3 wherein at least one wrap of the thread includes a deformation such that lip of the drum frictionally engages the deformation upon engagement of the coupling element with the drum.

15. The mounting assembly of claim 2:
wherein the drum portion of the support structure extends from a first surface of the support structure; and
wherein the support structure includes a plurality of bumps that extend from the first surface of the support structure.

16. The mounting assembly of claim 15 wherein each of the plurality of bumps extend the same distance from the first surface of the support structure.

17. The mounting assembly of claim 16 wherein each of the plurality of bumps comprises a dome-shaped hemispherical bump.

18. The mounting assembly of claim 17 wherein each of the plurality of dome-shaped hemispherical bumps comprises a dome-shaped hemispherical bump having the same radius of curvature.
